(19) United States
(12) Patent Application Publication
(10) Pub. No.: US 2026/0212886 A1
(43) Pub. Date: Jul. 23, 2026

(54) MAGNETIC RECORDING MEDIUM AND CARTRIDGE

(71) Applicant: Sony Group Corporation, Tokyo (JP)

(72) Inventor: Minoru YAMAGA, Tokyo (JP)

(21) Appl. No.: 19/143,124

(22) PCT Filed: Jan. 24, 2024
(86) PCT No.: PCT/JP2024/002000

§ 371 Date: Jun. 25, 2025

(30) Foreign Application Priority Data
Jan. 31, 2023 (JP) 2023-013681

(51) Int. Cl. G11B 5/706; G11B 5/592; G11B 5/714

(52) U.S. Cl. CPC G11B 5/70678; G11B 5/5928; G11B 5/714

(57) ABSTRACT

Provided is a magnetic recording medium capable of suppressing deterioration of electromagnetic conversion characteristics due to storage.

A magnetic recording medium is a magnetic recording medium in a tape shape, and includes a base and a magnetic layer containing ferrite particles and an acidic compound. An average particle volume of the ferrite particles is 1400 nm³ or less. A reduction rate of a saturation magnetization Ms in an environment of a temperature of 60° C. and a humidity of 90 RH % is 1.00 [%/8 weeks] or less.

### TECHNICAL FIELD

The present disclosure relates to a magnetic recording medium and a cartridge including the magnetic recording medium.

### BACKGROUND ART

In recent years, magnetic recording media in a tape shape are widely used for storage of electronic data. In order to increase a surface recording density of the magnetic recording medium in a tape shape, it is necessary to miniaturize ferrite particles. Patent Document 1 describes that an average particle volume of the ferrite particles is 1400 nm³ or less.

### CITATION LIST

### Patent Document

Patent Document 1: WO 2021/199453 A

### SUMMARY OF THE INVENTION

### Problems to be Solved by the Invention

Since the ferrite particles are oxides, the ferrite particles are considered to be stable magnetic particles with less deterioration due to rust and the like. However, when the average particle volume of the ferrite particles is 1400 nm³ or less in order to increase the surface recording density, electromagnetic conversion characteristics may be deteriorated during storage of the magnetic recording medium.

An object of the present disclosure is to provide a magnetic recording medium capable of suppressing deterioration of electromagnetic conversion characteristics due to storage, and a cartridge including the magnetic recording medium.

### Solutions to Problems

In order to solve the above-described problems, a magnetic recording medium according to the present disclosure is
a magnetic recording medium in a tape shape, including:
a base; and
a magnetic layer containing ferrite particles and an acidic compound, in which
an average particle volume of the ferrite particles is 1400 nm³ or less, and
a reduction rate of a saturation magnetization Ms in an environment at a temperature of 60° C. and a humidity of 90 RH % is 1.00 [%/8 weeks] or less.

A cartridge according to the present disclosure includes the magnetic recording medium according to the present disclosure.

### BRIEF DESCRIPTION OF DRAWINGS

FIG. 1 is an exploded perspective view illustrating an example of a configuration of a cartridge according to one embodiment of the present disclosure.

FIG. 2 is a block diagram illustrating an example of a configuration of a cartridge memory.

FIG. 3 is a cross-sectional view illustrating an example of a configuration of a magnetic tape.

FIG. 4 is a schematic diagram illustrating an example of a layout of data bands and servo bands.

FIG. 5 is an enlarged view illustrating an example of a configuration of a data band.

FIG. 6 is an enlarged view illustrating an example of a configuration of a servo band.

FIG. 7 is a perspective view illustrating an example of a shape of a particle.

FIG. 8 is a diagram illustrating a first example of a cross-sectional TEM image of a magnetic layer.

FIG. 9 is a diagram illustrating a second example of the cross-sectional TEM image of the magnetic layer.

FIG. 10 is a graph illustrating an example of a reproduction signal read by a spectrum analyzer.

FIG. 11 is a graph illustrating an example of a measurement result of an attenuation amount of a reproduction signal.

FIG. 12 is an exploded perspective view illustrating an example of a configuration of a cartridge according to a modification of an embodiment of the present disclosure.

FIG. 13 is a graph illustrating a measurement result of a reduction rate of a saturation magnetization Ms.

### MODE FOR CARRYING OUT THE INVENTION

Embodiments of the present disclosure are described in the following order.
1 Background to present disclosure
2 Configuration of cartridge
3 Configuration of cartridge memory
4 Configuration of magnetic tape
5 Manufacturing method of magnetic tape
6 Operations and effects
7 Modifications

In the present specification, in a case where a measurement method and an evaluation method are described without a particular description of a measurement environment, the measurement and the evaluation are performed under an environment of 25° C.±2° C. and 50% RH±5% RH.

### [1 Background to Present Disclosure]

According to the findings of the present inventor, when the average particle volume of the ferrite particles is 1400 nm³ or less in order to increase the surface recording density, as described above, electromagnetic conversion characteristics may be deteriorated during storage of the magnetic recording medium. The present inventor has conducted intensive studies on the cause of this deterioration in electromagnetic conversion characteristics. As a result, it has been found that the deterioration of the characteristics occurs as follows. When moisture diffuses into the magnetic layer during storage of the magnetic recording medium, an acidic compound contained in the magnetic layer is dissolved in the moisture, and an acidic aqueous solution may be generated. The acidic aqueous solution thus produced has a property of dissolving the ferrite particles. When the average particle volume of the ferrite particles is 1400 nm³ or less, since the specific surface area of the ferrite particles is large, the influence of dissolution of the ferrite particles by an acidic aqueous solution is likely to appear, and there is a possibility that magnetic characteristics are deteriorated. In particular, under a high temperature and high humidity environment (for example, in an environment of a temperature of 60° C. and a humidity of 90 RH %), the influence of the dissolution of the ferrite particles is likely to appear remarkably, and there is a possibility that the deterioration of the magnetic characteristics will increase.

Based on the above points, the present inventor has intensively studied a technique capable of suppressing deterioration of electromagnetic conversion characteristics due to storage even in a case where the average particle volume of ferrite particles is 1400 nm³ or less. As a result, the present inventors have found that deterioration of the above characteristics can be suppressed by setting the reduction rate of the saturation magnetization Ms in an environment of a temperature of 60° C. and a humidity of 90 RH % to 1.00 [%/8 weeks] or less.

### [2 Configuration of Cartridge]

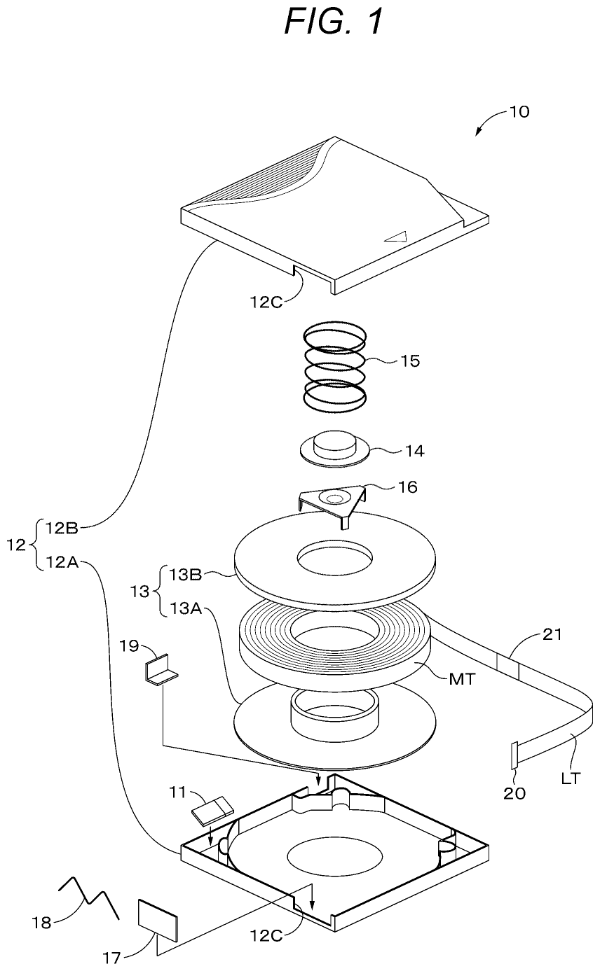

FIG. 1 is an exploded perspective view illustrating an example of a configuration of a cartridge 10. The cartridge 10 is a one-reel type cartridge, and includes one reel 13 around which a magnetic recording medium (hereinafter, referred to as a “magnetic tape”) MT in a tape shape is wound inside a cartridge case 12 including a lower shell 12A and an upper shell 12B, a reel lock 14 and a reel spring 15 for locking rotation of the reel 13, a spider 16 for releasing a locked state of the reel 13, a slide door 17 for opening and closing a tape drawing port 12C provided in the cartridge case 12 across the lower shell 12A and the upper shell 12B, a door spring 18 for biasing the slide door 17 to a closed position of the tape drawing port 12C, a write protect 19 for preventing erroneous erasure, and a cartridge memory 11. The reel 13 for winding the magnetic tape MT has a substantially disk shape having an opening in a central portion, and includes a reel hub 13A and a flange 13B including a hard material such as plastic. A reader tape LT is connected to an end portion on an outer peripheral side of the magnetic tape MT. A leader pin 20 is provided at a tip of the reader tape LT.

The cartridge 10 may be a magnetic tape cartridge according to a linear tape-open (LTO) standard, or may be a magnetic tape cartridge according to a standard different from the LTO standard.

The cartridge memory 11 is provided near one corner of the cartridge 10. In a state where the cartridge 10 is loaded into a recording/reproducing device, the cartridge memory 11 faces a reader-writer of the recording/reproducing device. The cartridge memory 11 communicates with the recording/reproducing device, specifically, with the reader-writer by a wireless communication standard according to the LTO standard.

### [3 Configuration of Cartridge Memory]

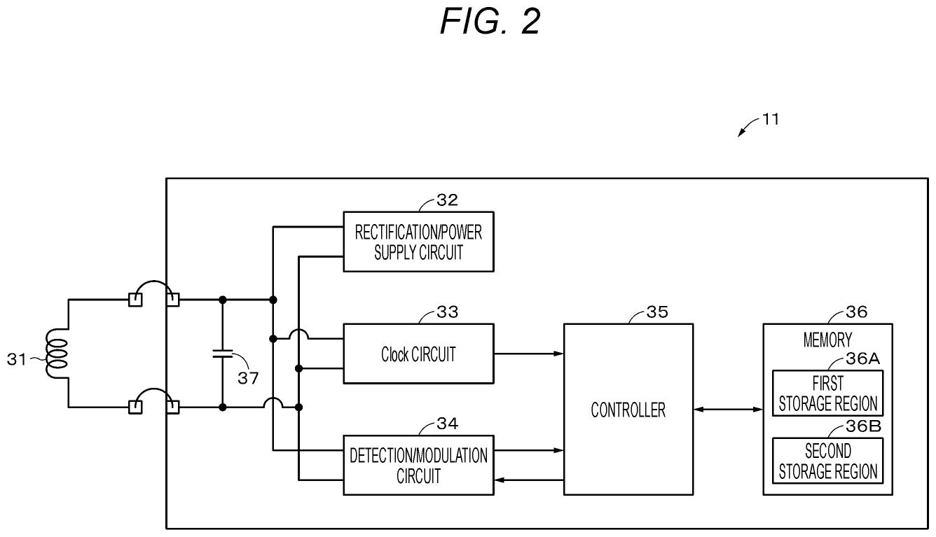

FIG. 2 is a block diagram illustrating an example of a configuration of the cartridge memory 11. The cartridge memory 11 includes an antenna coil (communication section) 31 that communicates with the reader-writer according to a prescribed communication standard, a rectification/power supply circuit 32 that generates electric power from an electric wave received from the antenna coil 31 by use of an induced electromotive force, and rectifies the electric power to generate a power supply, a clock circuit 33 that generates a clock from the electric wave received from the antenna coil 31 by similarly using the induced electromotive force, a detection/modulation circuit 34 that performs detection of the electric wave received from the antenna coil 31 and modulation of a signal to be transmitted from the antenna coil 31, a controller (control section) 35 including a logical circuit or the like for discriminating commands and data from a digital signal extracted from the detection/modulation circuit 34 and for processing the commands and data, and a memory (storage section) 36 that stores information. Furthermore, the cartridge memory 11 includes a capacitor 37 connected in parallel to the antenna coil 31, and the antenna coil 31 and the capacitor 37 constitute a resonance circuit.

The memory 36 stores information concerning the cartridge 10 and the like. The memory 36 is a non-volatile memory (NVM). The memory 36 preferably has a storage capacity of about 32 KB or more.

The memory 36 may include a first storage region 36A and a second storage region 36B. The first storage region 36A corresponds to, for example, a storage region of a cartridge memory of a magnetic tape standard before a specified generation (for example, LTO standards before LTO8), and is a region for storing information according to the magnetic tape standard before the specified generation. The information according to the magnetic tape standard before the specified generation is, for example, manufacturing information (for example, specific number of the cartridge 10 or the like), use history (for example, the number of times of tape draw-out (Thread Count)), and the like.

The second storage region 36B corresponds to an extension storage region in regard of the storage region of the cartridge memory of the magnetic tape standard before the specified generation (for example, LTO standards before LTO8). The second storage region 36B is a region for storing additional information. Here, the additional information means, for example, information concerning the cartridge 10 that is not prescribed in the magnetic tape standard before the specified generation (for example, LTO standards before LTO8). The additional information includes, for example, at least one type of information selected from the group consisting of tension adjustment information, management ledger data, index information, thumbnail information, and the like, but is not limited to these data. The tension adjustment information is information for adjusting the tension applied to the magnetic tape MT in the longitudinal direction. The tension adjustment information includes, for example, at least one type of information selected from the group consisting of information obtained by intermittently measuring a width between servo bands in the longitudinal direction of the magnetic tape MT, drive tension information, drive temperature and humidity information, and the like. These pieces of information may be managed in cooperation with information associated with a usage status of the cartridge 10 or the like. The tension adjustment information is preferably acquired at the time of data recording on the magnetic tape MT or before data recording. The drive tension information means information on the tension applied to the magnetic tape MT in the longitudinal direction.

The management ledger data is data including at least one type selected from the group consisting of the capacity, creation date, editing date, storage location, and the like of a data file recorded on the magnetic tape MT. The index information is metadata or the like for searching the content of the data file. The thumbnail information is a thumbnail of a moving image or a still image stored on the magnetic tape MT.

The memory 36 may include a plurality of banks. In this case, some of the plurality of banks may constitute the first storage region 36A, and the remaining banks may constitute the second storage region 36B.

The antenna coil 31 induces an induced voltage by electromagnetic induction. The controller 35 communicates with the recording/reproducing device according to a prescribed communication standard through the antenna coil 31. Specifically, for example, mutual authentication, transmission and reception of commands, and exchange of data are performed.

The controller 35 stores information received from the recording/reproducing device through the antenna coil 31 in the memory 36. For example, the tension adjustment information received from the recording/reproducing device through the antenna coil 31 is stored in the second storage region 36B of the memory 36. In response to a request from the recording/reproducing device, the controller 35 reads information from the memory 36, and transmits the information to the recording/reproducing device through the antenna coil 31. For example, in response to the request from the recording/reproducing device, the tension adjustment information is read from the second storage region 36B of the memory 36 and transmitted to the recording/reproducing device through the antenna coil 31.

### [4 Configuration of Magnetic Tape]

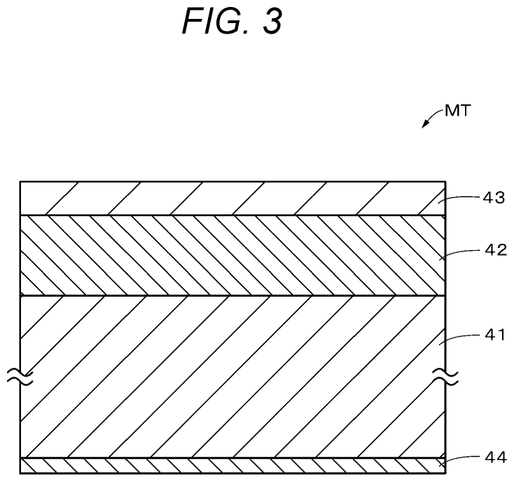

FIG. 3 is a cross-sectional view illustrating an example of a configuration of the magnetic tape MT. The magnetic tape MT is provided with an elongated base 41, an underlayer 42 provided on one principal surface (first principal surface) of the base 41, a magnetic layer 43 provided on the underlayer 42, and a back layer 44 provided on the other principal surface (second principal surface) of the base 41. Note that the underlayer 42 and the back layer 44 are provided as necessary and they are not necessarily provided. The magnetic tape MT may be a perpendicular recording type magnetic recording medium or may be a longitudinal recording type magnetic recording medium. The magnetic tape MT preferably contains a lubricant from the viewpoint of improving traveling performance. The lubricant may be contained in at least one of the underlayer 42 or the magnetic layer 43.

The magnetic tape MT may conform to the LTO standard, or may conform to a standard different from the LTO standard. The width of the magnetic tape MT may be ½ inches, or may be wider than ½ inches. In a case where the magnetic tape MT conforms to the LTO standard, the width of the magnetic tape MT is ½ inches. The magnetic tape MT may have a configuration in which the width of the magnetic tape MT can be kept constant or substantially constant by adjusting tension, applied in the longitudinal direction of the magnetic tape MT during traveling, by the recording/reproducing device (drive).

The magnetic tape MT has an elongated shape and runs in the longitudinal direction during recording and reproducing. The magnetic tape MT is preferably used in a recording/reproducing device provided with a ring head as a recording head. From a viewpoint of improving the total capacity of the magnetic tape MT, it is preferable that the average thickness of the magnetic tape MT is 5.30 μm, and the magnetic layer 43 can record a signal with a data track width of 800 nm or less and a bit length of 46 nm or less.

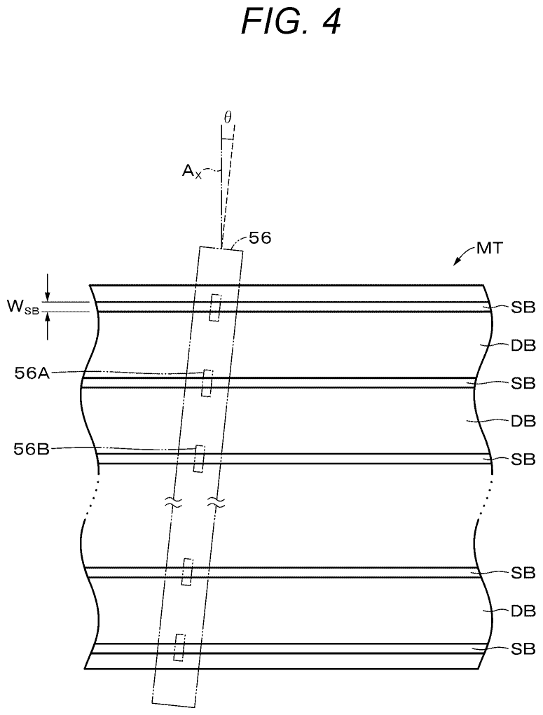

The magnetic tape MT is preferably reproduced by a reproducing head using a TMR element. The signal reproduced by the reproducing head using TMR may be data recorded in a data band DB (see FIG. 4) or a servo pattern (servo signal) recorded in a servo band SB (see FIG. 4).

### (Base)

The base 41 is a nonmagnetic supporting body which supports the underlayer 42 and the magnetic layer 43. The base 41 has an elongated film shape. An upper limit value of the average thickness of the base 41 is preferably 4.40 μm or less, more preferably 4.20 μm or less, still more preferably 4.00 μm or less, particularly preferably 3.80 μm or less, and most preferably 3.40 μm or less. When the upper limit value of the average thickness of the base 41 is 4.40 μm or less, a recording capacity which can be recorded in one data cartridge can be increased as compared with that in a general magnetic tape. A lower limit value of the average thickness of the base 41 is preferably 3.00 μm or more, and more preferably 3.20 μm or more. When the lower limit value of the average thickness of the base 41 is 3.00 μm or more, reduction in strength of the base 41 can be suppressed.

The average thickness of the base 41 is obtained as follows. First, the magnetic tape MT accommodated in the cartridge 10 is unwound, and the magnetic tape MT is cut out to a length of 250 mm at a position of 30 m to 40 m in a longitudinal direction from one end on an outer peripheral side of the magnetic tape MT, thereby preparing a sample. In the present specification, the “longitudinal direction” in the case of the “longitudinal direction from one end on outer peripheral side of magnetic tape MT” means a direction from one end on the outer peripheral side toward the other end on an inner peripheral side of the magnetic tape MT.

Subsequently, layers other than the base 41 of the sample (that is, the underlayer 42, the magnetic layer 43, and the back layer 44) are removed by a solvent such as methyl ethyl ketone (MEK) or dilute hydrochloric acid. Next, a thickness of the sample (base 41) is measured in five positions using a laser holo gauge (LGH-110C) manufactured by Mitutoyo as a measurement device, and simply averages (arithmetically averages) the measured values to calculate the average thickness of the base 41. Note that the five measurement positions described above are randomly selected from the sample so as to be different positions in the longitudinal direction of the magnetic tape MT.

The base 41 contains, for example, a polyester-based resin as a main component. The polyester-based resin contains, for example, at least one type selected from the group consisting of polyethylene terephthalate (PET), polyethylene naphthalate (PEN), polybutylene terephthalate (PBT), polybutylene naphthalate (PBN), polycyclohexylenedimethylene terephthalate (PCT), polyethylene-p-oxybenzoate (PEB), and polyethylene bisphenoxycarboxylate. In a case where the base 41 contains two or more types of polyester-based resins, the two or more types of polyester-based resins may be mixed, copolymerized, or stacked. At least one of a terminal and a side chain of the polyester-based resin may be modified. In addition to the polyester-based resin, the base 41 may contain a resin described later other than the polyester-based resin.

In the present specification, the “main component” means a component having the highest content ratio among the components constituting the base 41. For example, in a case where the main component of the base 41 is a polyester-based resin, a content ratio of the polyester-based resin in the base 41 may be, for example, 50% by mass or more, 60% by mass or more, 70% by mass or more, 80% by mass or more, 90% by mass or more, 95% by mass or more, or 98% by mass or more with respect to the mass of the base 41, or the base 41 may contain only polyester-based resin.

The inclusion of the polyester-based resin in the base 41 is confirmed, for example, as follows. First, similarly to the method of measuring the average thickness of the base 41, the magnetic tape MT is prepared, and cut into a length of 250 mm to prepare a sample, and then layers other than the base 41 of the sample are removed. Next, an IR spectrum of the sample (base 41) is acquired by infrared absorption spectroscopy (IR). On the basis of this IR spectrum, it can be confirmed that the polyester-based resin is contained in the base 41.

The base 41 preferably contains the polyester-based resin. When the base 41 contains the polyester-based resin, the Young's modulus of the base 41 in the longitudinal direction can be reduced to preferably 2.5 GPa or more and 7.8 GPa or less, and more preferably 3.0 GPa or more and 7.0 GPa or less. Therefore, the width of the magnetic tape MT can be kept constant or substantially constant by adjusting the tension in the longitudinal direction of the magnetic tape MT during traveling by the recording/reproducing device. A method of measuring the Young's modulus of the base 41 in the longitudinal direction will be described later.

The base 41 may contain a resin other than the polyester-based resin. In this case, the resin other than the polyester-based resin may be the main component of a configuration material of the base 41. For example, in a case where the resin other than the polyester-based resin is the main component of the base 41, a content ratio of the resin other than the polyester-based resin in the base 41 may be, for example, 50% by mass or more, 60% by mass or more, 70% by mass or more, 80% by mass or more, 90% by mass or more, 95% by mass or more, or 98% by mass or more with respect to the mass of the base 41, or the base 41 may contain only the resin other than the polyester-based resin. The resin other than the polyester-based resin contains, for example, at least one selected from the group consisting of a polyolefin-based resin, a cellulose derivative, a vinyl-based resin, and other polymer resins. In a case where the base 41 contains two or more types of these resins, the two or more types of materials may be mixed, copolymerized, or stacked.

The polyolefin-based resin contains, for example, at least one selected from the group consisting of polyethylene (PE) and polypropylene (PP). The cellulose derivative contains, for example, at least one selected from the group consisting of cellulose diacetate, cellulose triacetate, cellulose acetate butyrate (CAB), or cellulose acetate propionate (CAP). The vinyl-based resin contains, for example, at least one selected from the group consisting of polyvinyl chloride (PVC) or polyvinylidene chloride (PVDC).

Other polymer resins include, for example, at least one type selected from the group consisting of polyether ether ketone (PEEK), polyamide, (PA, nylon), aromatic polyamide (aromatic PA, aramid), polyimide (PI), aromatic polyimide (aromatic PI), polyamide imide (PAI), aromatic polyamide imide (aromatic PAI), polybenzoxazole (PBO, for example, ZYLON (registered trademark)), polyether, polyether ketone (PEK), polyether ester, polyether sulfone (PES), polyether imide (PEI), polysulfone (PSF), polyphenylene sulfide (PPS), polycarbonate (PC), polyarylate (PAR), and polyurethane (PU). Specifically, the base 41 contains, for example, polyether ether ketone (PEEK), polyamide, (PA, nylon), aromatic polyamide (aromatic PA, aramid), polyimide (PI), aromatic polyimide (aromatic PI), polyamide imide (PAI), aromatic polyamide imide (aromatic PAI), polybenzoxazole (PBO, for example, ZYLON (registered trademark)), polyether, polyether ketone (PEK), polyether ester, polyether sulfone (PES), polyether imide (PEI), polysulfone (PSF), polyphenylene sulfide (PPS), polycarbonate (PC), polyarylate (PAR), or polyurethane (PU) as a main component.

The base 41 may be biaxially stretched in the longitudinal direction and the width direction. The polymer resin contained in the base 41 is preferably oriented in an oblique direction with respect to the width direction of the base 41.

### (Magnetic Layer)

The magnetic layer 43 is configured to be able to record a signal by a magnetization pattern. The magnetic layer 43 may be a perpendicular recording type recording layer or may be a longitudinal recording type recording layer. The magnetic layer 43 contains, for example, ferrite particles as magnetic particles, a binder, and an additive. The additive includes an acidic compound. The additive may further contain at least one type selected from the group consisting of conductive particles, abrasive particles, a lubricant, an antistatic agent, a curing agent, a rust-preventive agent, and nonmagnetic reinforcing particles, as necessary. The magnetic layer 43 may include a plurality of protrusions on the surface (hereinafter, the magnetic surface is appropriately referred to as a “magnetic surface”) on the magnetic layer 43 side. The plurality of protrusions contains, for example, conductive particles and abrasive particles protruding from the magnetic surface.

The magnetic layer 43 may include a plurality of the servo bands SB and a plurality of the data bands DB in advance as illustrated in FIG. 4. The plurality of servo bands SB is provided at equal intervals in a width direction of the magnetic tape MT. The data band DB is provided between the adjacent servo bands SB. The servo band SB is for guiding a head unit (magnetic head) 56 (specifically, servo read heads 56A and 56B) at the time of recording or reproducing data. In the servo band SB, a servo pattern (servo signal) for performing tracking control on the head unit 56 is written in advance. User data is recorded in the data band DB.

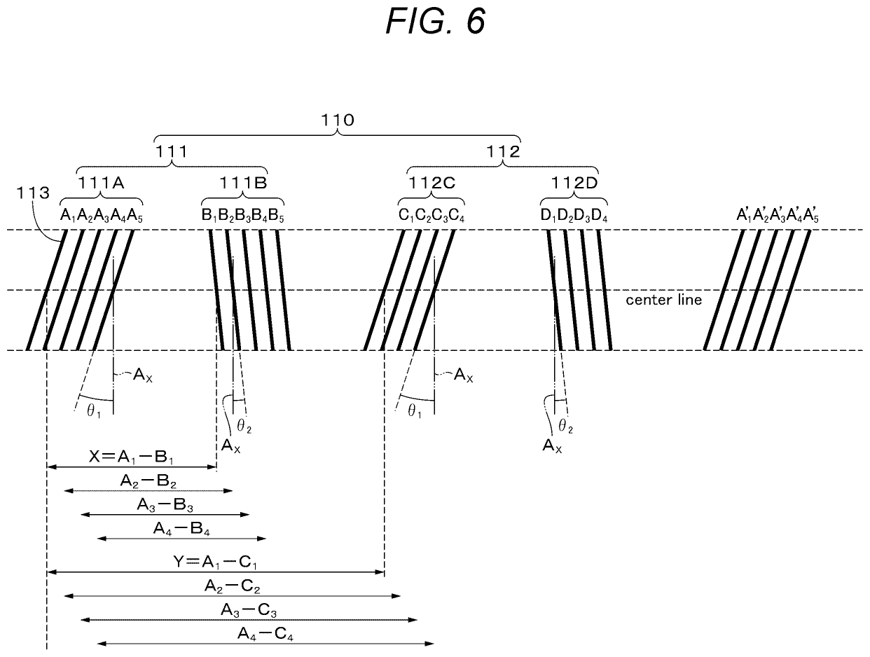

In order to read an asymmetric servo stripe 113 (see FIG. 6) to be described later, as illustrated in FIG. 4, the head unit 56 may be configured to be able to be maintained obliquely with respect to an axis Ax parallel to the width direction of the magnetic tape MT at the time of recording and reproducing data. Alternatively, the head unit 56 may be configured to be inclined with respect to the axis Ax following the meandering or deformation of the magnetic tape MT at the time of recording and reproducing data. The inclination angle of the head unit 56 based on the axis Ax parallel to the width direction of the magnetic tape MT is preferably 3° or more and 18° or less, and more preferably 5° or more and 15° or less.

An upper limit value of a ratio R_{S} (=(S_{SB}/S)×100) of a total area S_{SB} of the plurality of servo bands SB to an area S of the magnetic surface (surface of a magnetic layer 43 side) is preferably 4.0% or less, more preferably 3.5% or less, and still more preferably 3.0% or less from a viewpoint of securing a high recording capacity. On the other hand, a lower limit value of the ratio R_{S} of the total area S_{SB} of the plurality of servo bands SB to the area S of the magnetic surface is preferably 1.0% or more from a viewpoint of securing five or more servo bands SB.

The ratio R_{S} of the total area S_{SB} of the plurality of servo bands SB to the area S of the entire magnetic surface is obtained as follows. The magnetic tape MT is developed using a ferri-colloid developer (Sigmarker Q, produced by Sigma Hi-Chemical), then the developed magnetic tape MT is observed under an optical microscope, to measure a servo band width W_{SB} and the number of the servo bands SB. Next, the ratio R_{S} is obtained from the following formula.

$$Ratio {R}_{s} [ \% ] = ( ( ( servo band width {W}_{SB} ) \times ( number of servo bands SB ) ) / ( width of magnetic tape MT ) ) \times 100$$

The number of servo bands SB is, for example, 5+4n (where n is an integer of 0 or more) or more. The number of servo bands SB is preferably 5 or more, and more preferably 9 or more. When the number of servo bands SB is 5 or more, an effect of a dimensional change in the width direction of the magnetic tape MT on the servo signal is suppressed, and stable recording/reproducing characteristics with smaller off-track can be secured. An upper limit value of the number of servo bands SB is not especially limited, but is, for example, 33 or less.

The number of servo bands SB is obtained similarly to the above-described measurement method of the ratio R_{S}.

An upper limit value of the servo band width W_{SB} is preferably 95 μm or less, more preferably 65 μm or less, and still more preferably 50 μm or less from a viewpoint of securing the high recording capacity. A lower limit value of the servo band width W_{SB} is preferably 10 μm or more. It is difficult to manufacture a magnetic head capable of reading a servo signal having a servo band width W_{SB} of less than 10 μm.

The width of the servo band width W_{SB} is obtained similarly to the above-described measurement method of the ratio R_{S}.

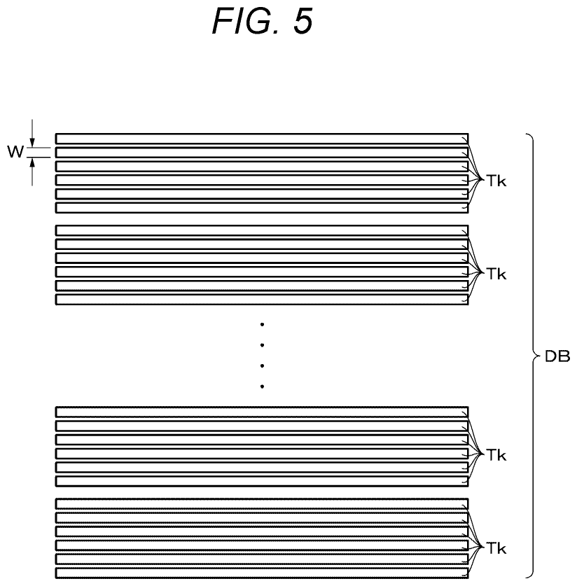

The magnetic layer 43 is configured to be able to form a plurality of data tracks Tk in the data band DB, as illustrated in FIG. 5. An upper limit value of a data track width W is preferably 1200 nm or less, 1000 nm or less, 850 nm or less, or 800 nm or less, and particularly preferably 600 nm or less from a viewpoint of improving a track recording density and securing a high recording capacity. A lower limit value of the data track width W is preferably 20 nm or more in consideration of a size of the ferrite particles.

The data track width W is obtained as follows. First, the cartridge 10 in which data is recorded on the entire surface of the magnetic tape MT is prepared, the magnetic tape MT is unwound from the cartridge 10, and the magnetic tape MT is cut out to a length of 250 mm at a position of 30 m to 40 m in the longitudinal direction from one end of the outer peripheral side of the magnetic tape MT, thereby preparing a sample. Subsequently, a data recording pattern of a data band DB portion of the magnetic layer 43 of the sample is observed using a magnetic force microscope (MFM) to obtain an MFM image. As the MFM, Dimension3100 manufactured by Digital Instruments, Inc. and its analysis software are used. A measurement region for the MFM image is 10 μm×10 μm, and the measurement region of 10 μm×10 μm is divided into 512×512 (=262,144) measurement points. Measurement by MFM is conducted for three 10 μm×10 μm measurement regions at different locations, and, thus, three MEM images are obtained. The track width is measured at 10 points in each of the obtained 3 MFM images, the measured values at 30 points in total are acquired, and the average value (simple average) of the measured values at 30 points is calculated. The average value is the data track width W. For the measurement of the track width, analysis software attached to Dimension3100 is used. Note that measurement conditions for the MFM described above are scanning speed: 1 Hz, chip used: MEMR-20, lift height: 20 nm, and correction: Flatten order 3.

The magnetic layer 43 is configured to be able to record the data so that a minimum value Imin of a distance between magnetization reversals is preferably 47 nm or less, more preferably 44 nm or less, still more preferably 42 nm or less, and particularly preferably 40 nm or less from a viewpoint of securing a high recording capacity. A lower limit value of the minimum value Lₘᵢₙ of the distance between magnetization reversals is preferably 20 nm or more in consideration of a size of the ferrite particles.

The minimum value Lₘᵢₙ of the distance between magnetization reversals is obtained as follows. First, a sample is prepared in a similar manner to the method of measuring the data track width W. Subsequently, a data recording pattern of a data band DB portion of the magnetic layer 43 of the sample is observed using a magnetic force microscope (MFM) to obtain an MFM image. As the MFM, Dimension3100 manufactured by Digital Instruments, Inc. and its analysis software are used. A measurement region for the MFM image is 2 μm×2 μm, and the measurement region of 2 μm×2 μm is divided into 512×512 (=262, 144) measurement points. Measurement by MFM is conducted for three 2 μm×2 μm measurement regions at different locations, and, thus, three MFM images are obtained. From two-dimensional rugged charts of record patterns of the MFM images thus obtained, the distance between bits is measured at 50 locations. The measurement of the distance between bits is conducted using the analysis software attached to Dimension3100. A value approximately equal to the greatest common divisor of the measured 50 distances between bits is made to be the minimum value Lₘᵢₙ of the distance between magnetization reversals. Note that measurement conditions are scanning speed: 1 Hz, chip used: MFMR-20, lift height: 20 nm, and correction: Flatten order 3.

A bit length L_{bit} of the signal recorded in the data band DB is preferably 47 nm or less or 46 nm or less, more preferably 44 nm or less, still more preferably 42 nm or less, and particularly preferably 40 nm or less from a viewpoint of improving the recording density of the magnetic tape MT.

The bit length L_{bit} of the signal recorded in the data band DB is obtained in a similar manner to the method of measuring the minimum value Lₘᵢₙ of the distance between magnetization inversions.

The bit area of the signal recorded in the data band DB is preferably 53000 nm² or less, more preferably 45000 nm² or less, still more preferably 37000 nm² or less, and particularly preferably 30000 nm² or less from a viewpoint of improving the recording density of the magnetic tape MT.

The bit area of the signal recorded in the data band DB is obtained as follows. First, three MFM images are obtained similarly to the method of measuring the data track width W. Next, the data track width W and the bit length L_{bit} are obtained in a similar manner to the method of measuring the data track width W and the method of measuring the bit length L_{bit}. Next, the bit area (W×L_{bit}) of the signal recorded in the data band DB is obtained using the data track width W and the bit length L_{bit}.

The servo pattern is a magnetization region, and is formed by magnetizing a specific region of the magnetic layer 43 in a specific direction by a servo write head at the time of manufacturing the magnetic tape. In the servo band SB, a region where no servo pattern is formed (hereinafter, referred to as a “non-pattern region”) may be a magnetized region where the magnetic layer 43 is magnetized or a non-magnetized region where the magnetic layer 43 is not magnetized. In a case where the non-pattern region is the magnetization region, the servo pattern-formed region and the non-pattern region are magnetized in different directions (for example, opposite directions).

In the LTO standard, as illustrated in FIG. 6, a servo pattern including a plurality of servo stripes (linear magnetization regions) 113 inclined with respect to an axis Ax parallel to the width direction of the magnetic tape MT is formed on the servo band SB.

The servo band SB includes a plurality of servo frames 110. Each of the servo frames 110 includes eighteen servo stripes 113. Specifically, each of the servo frames 110 includes a servo subframe 1 (111) and a servo subframe 2 (112).

The servo subframe 1 (111) includes an A burst 111A and a B burst 111B. The B burst 111B is disposed adjacent to the A burst 111A. The A burst 111A includes five servo stripes 113 inclined at a predetermined angle θ₁ with respect to the axis Ax parallel to the width direction of the magnetic tape MT and formed at specified intervals. In FIG. 6, these five servo stripes 113 are denoted by reference signs A₁, A₂, A₃, A₄, and A₅ from an end of tape (EOT) to a beginning of tape (BOT) of the magnetic tape MT.

The B burst 111B includes five servo stripes 113 inclined at a predetermined angle θ₂ with respect to the axis Ax parallel to the width direction of the magnetic tape MT and formed at specified intervals. In FIG. 6, these five servo stripes 113 are denoted by reference signs B₁, B₂, B₃, B₄, and B₅ from the EOT to the BOT of the magnetic tape MT.

The servo stripes 113 of the B burst 111B are inclined in a direction opposite to the servo stripes 113 of the A burst 111A. The servo stripes 113 of the A burst 111A and the servo stripes 113 of the B burst 111B have asymmetry with respect to the axis Ax parallel to the width direction of the magnetic tape MT. That is, the servo stripes 113 of the A burst 111A and the servo stripes 113 of the B burst 111B are disposed in a roughly chevron shape. Since the servo stripes 113 of the A burst 111A and the servo stripes 113 of the B burst 111B have asymmetry with respect to the axis Ax, when the head unit 56 is inclined obliquely with respect to the axis Ax, there is a state in which the servo stripes 113 of the A burst 111A and the servo stripes 113 of the B burst 111B are substantially symmetrical with respect to the central axis of the sliding surface of the head unit 56. By changing the inclination of the head unit 56 with reference to this state, the distance between the servo read heads 56A and 56B in the width direction of the magnetic tape MT can be adjusted. Therefore, in both the case where the width of the magnetic tape MT is increased and the case where the width of the magnetic tape MT is decreased, the servo read heads 56A and 56B can be opposed to the specified positions of the servo bands SB. Note that the central axis of the sliding surface of the head unit 56 means an axis passing through the centers of the plurality of servo read heads 56A and 56B on the sliding surface of the head unit 56.

The predetermined angle θ₁ that is an inclination angle of the servo stripe 113 of the A burst 111A is different from the predetermined angle θ₂ that is an inclination angle of the servo stripe 113 of the B burst 111B. More specifically, the predetermined angle θ₁ of the servo stripe 113 of the A burst 111A may be larger than the predetermined angle θ₂ of the servo stripe 113 of the B burst 111B, or the predetermined angle θ₂ of the servo stripe 113 of the B burst 111B may be larger than the predetermined angle θ₁ of the servo stripe 113 of the A burst 111A. That is, the inclination of the servo stripe 113 of the A burst 111A may be larger than the inclination of the servo stripe 113 of the B burst 111B, or the inclination of the servo stripe 113 of the B burst 111B may be larger than the inclination of the servo stripe 113 of the A burst 111A. Note that FIG. 6 illustrates an example in which the predetermined angle θ₁ of the servo stripe 113 of the A burst 111A is larger than the predetermined angle θ₂ of the servo stripe 113 of the B burst 111B. Hereinafter, a case where the predetermined angle θ₁ of the servo stripe 113 of the A burst 111A is larger than the predetermined angle θ₂ of the servo stripe 113 of the B burst 111B will be described.

The servo subframe 2 (112) includes a C burst 112C and a D burst 112D. The D burst 112D is disposed adjacent to the C burst 112C. The C burst 112C includes four servo stripes 113 inclined at the predetermined angle θ₁ with respect to the axis Ax parallel to the width direction of the magnetic tape MT and formed at specified intervals. In FIG. 6, these four servo stripes 113 are denoted by reference signs C₁, C₂, C₃, and C₄ from the EOT to the BOT of the magnetic tape MT.

The D burst 112D includes four servo stripes 113 inclined at the predetermined angle θ₂ with respect to the axis Ax parallel to the width direction of the magnetic tape MT and formed at specified intervals. In FIG. 6, these four servo stripes 113 are denoted by reference signs D₁, D₂, D₃, and D₄ from the EOT to the BOT of the magnetic tape MT.

The servo stripes 113 of the D burst 112D are inclined in a direction opposite to the servo stripes 113 of the C burst 112C. The servo stripes 113 of the C burst 112C and the servo stripes 113 of the D burst 112D have asymmetry with respect to the axis Ax parallel to the width direction of the magnetic tape MT. That is, the servo stripes 113 of the C burst 112C and the servo stripes 113 of the D burst 112D are disposed in a roughly chevron shape. Since the servo stripes 113 of the C burst 112C and the servo stripes 113 of the D burst 112D have asymmetry with respect to the axis Ax, when the head unit 56 is inclined obliquely with respect to the axis Ax, there is a state in which the servo stripes 113 of the C burst 112C and the servo stripes 113 of the D burst 112D are substantially symmetrical with respect to the central axis of the head unit 56. The inter-servo distance can be adjusted by changing the inclination of the head unit 56 with reference to this state.

The predetermined angle θ₁ that is an inclination angle of the servo stripe 113 of the C burst 112C is different from the predetermined angle θ₂ that is an inclination angle of the servo stripe 113 of the D burst 112D. More specifically, the predetermined angle θ₁ of the servo stripe 113 of the C burst 112C may be larger than the predetermined angle θ₂ of the servo stripe 113 of the D burst 112D, or the predetermined angle θ₂ of the servo stripe 113 of the D burst 112D may be larger than the predetermined angle θ₁ of the servo stripe 113 of the C burst 112C. That is, the inclination of the servo stripe 113 of the C burst 112C may be larger than the inclination of the servo stripe 113 of the D burst 112D, or the inclination of the servo stripe 113 of the D burst 112D may be larger than the inclination of the servo stripe 113 of the C burst 112C. Note that FIG. 6 illustrates an example in which the predetermined angle θ₁ of the servo stripe 113 of the C burst 112C is larger than the predetermined angle θ₂ of the servo stripe 113 of the D burst 112D. Hereinafter, a case where the predetermined angle θ₁ of the servo stripe 113 of the C burst 112C is larger than the predetermined angle θ₂ of the servo stripe 113 of the D burst 112D will be described.

The predetermined angle θ₁ of the servo stripe 113 in the A burst 111A and the C burst 112C is preferably 18° or more and 28° or less, and more preferably 18° or more and 26° or less. The predetermined angle θ₂ of the servo stripe 113 in the B burst 111B and the D burst 112D is preferably −4° or more and 6° or less, and more preferably −2° or more and 6° or less. The servo stripe 113 in the A burst 111A and the C burst 112C is an example of a first magnetization region. The servo stripe 113 in the B burst 111B and the D burst 112D is an example of a second magnetization region.

By reading the servo band SB with the head unit 56, information for acquiring a tape speed and a position of the head unit 56 in a vertical direction can be obtained. The tape speed is calculated from the time between four timing signals (A1-C1, A2-C2, A3-C3, A4-C4). The head position is calculated from the time between the four timing signals described above and the time between another four timing signals (A1-B1, A2-B2, A3-B3, A4-B4). The servo pattern may have a shape including two parallel lines.

As illustrated in FIG. 6, the servo patterns (that is, the plurality of servo stripes 113) are preferably linearly arranged in the longitudinal direction of the magnetic tape MT. That is, the servo band SB preferably has a linear shape in the longitudinal direction of the magnetic tape MT.

An upper limit value of an average thickness of the magnetic layer 43 is preferably 0.08 μm or less, more preferably 0.065 μm or less, and still more preferably 0.055 μm or less. When the upper limit value of the average thickness t₁ of the magnetic layer 43 is 0.08 μm or less, an influence of a demagnetizing field can be reduced in a case where a ring type head is used as a recording head, and therefore more excellent electromagnetic conversion characteristics can be obtained.

A lower limit value of the average thickness t₁ of the magnetic layer 43 is preferably 0.035 μm or more. When the lower limit value of the average thickness t₁ of the magnetic layer 43 is 0.035 μm or more, an output can be secured in a case where an MR head is used as a reproducing head, and therefore more excellent electromagnetic conversion characteristics can be obtained.

The average thickness t₁ of the magnetic layer 43 is obtained as follows. First, the magnetic tape MT accommodated in the cartridge 10 is unwound, and the magnetic tape MT is cut out into a length of 250 mm from each of a position of 10 m to 20 m, a position of 30 m to 40 m, and a position of 50 m to 60 m in the longitudinal direction from one end on an outer peripheral side of the magnetic tape MT to prepare three samples. Subsequently, each sample is processed by a FIB method or the like to perform thinning. In a case where the FIB method is used, formation of a carbon layer and a tungsten layer as protective films is performed as pre-processing for observing a TEM image of a cross section described below. The carbon layer is formed on a surface on the magnetic layer 43 side and a surface on the back layer 44 side of the magnetic tape MT by a vapor deposition method, and then the tungsten layer is further formed on the surface of the magnetic layer 43 by a vapor deposition method or a sputtering method. The thinning is performed in the longitudinal direction of the magnetic tape MT. That is, a cross section parallel to both the longitudinal direction and the thickness direction of the magnetic tape MT is formed by the thinning.

The above-described obtained cross section of each thinned sample is observed with a transmission electron microscope (TEM) under the following conditions, and thus a TEM image of each thinned sample is obtained. Note that the magnification and the acceleration voltage may be appropriately adjusted according to the type of the device.

Device: TEM (H9000NAR manufactured by Hitachi, Ltd.)

Acceleration voltage: 300 kV

Magnification: 100,000 times

Next, the thickness of the magnetic layer 43 is measured at ten positions of each resulting thinned sample using the obtained TEM image of each thinned sample. Note that the ten measurement positions of each thinned sample are randomly selected from the sample so as to be different positions in the longitudinal direction of the magnetic tape MT. An average value obtained by simply averaging (arithmetically averaging) the obtained measured values (the thicknesses of the magnetic layers 43 at thirty points in total) of each thinned sample is defined as an average thickness t₁ [nm] of the magnetic layer 43.

### (Ferrite Particles)

The ferrite particles contain, for example, particles containing hexagonal ferrite (hereinafter, referred to as “hexagonal ferrite particles”), particles containing epsilon-type iron oxide (ε-iron oxide) (hereinafter, referred to as “ε-iron oxide particles”), or particles containing Co-containing spinel ferrite (hereinafter, referred to as “cobalt ferrite particles”). The ferrite particles are preferably crystal oriented preferentially in the vertical direction of the magnetic tape MT. In the present specification, the vertical direction (thickness direction) of the magnetic tape MT means the thickness direction of the magnetic tape MT in a planar state.

### (Hexagonal Ferrite Particles)

The hexagonal ferrite particles have, for example, a plate-like shape such as a hexagonal plate-like shape or a columnar shape such as a hexagonal columnar shape (however, the thickness or height is smaller than the major axis of the plate surface or the bottom surface). In the present specification, the hexagonal plate-like shape includes a substantially hexagonal plate-like shape. Furthermore, the hexagonal column shape includes a substantially hexagonal column shape. However, hexagonal ferrite contains preferably at least one type selected from the group consisting of Ba, Sr, Pb, and Ca, and more preferably at least one type selected from the group consisting of Ba and Sr. Specifically, the hexagonal ferrite may be, for example, barium ferrite or strontium ferrite. The barium ferrite may further contain at least one type selected from the group consisting of Sr, Pb, and Ca, in addition to Ba. The strontium ferrite may further contain at least one type selected from the group consisting of Ba, Pb, and Ca, in addition to Sr.

More specifically, the hexagonal ferrite has an average composition represented by general formula MFe₁₂O₁₉. However, M is, for example, at least one type of metal selected from the group consisting of Ba, Sr, Pb, and Ca, and preferably at least one metal selected from the group consisting of Ba and Sr. M may be a combination of Ba and at least one type of metal selected from the group consisting of Sr, Pb, and Ca. Furthermore, M may be a combination of Sr and at least one type of metal selected from the group consisting of Ba, Pb, and Ca. A part of Fe in the above-described general formula may be substituted with another metal element.

In a case where the ferrite particles contain hexagonal ferrite particles, an upper limit value of the average particle size of the hexagonal ferrite particles is preferably 18.0 nm or less, more preferably 16.0 nm or less, and still more preferably 15.0 nm or less. When the upper limit value of the average particle size of the hexagonal ferrite particles is 18.0 nm or less, more excellent electromagnetic conversion characteristics (for example, SNR) can be obtained in the magnetic tape MT of high recording density.

In a case where the ferrite particles contain hexagonal ferrite particles, a lower limit value of the average particle size of the hexagonal ferrite particles is preferably 11.0 nm or more, more preferably 12.0 nm or more, and still more preferably 13.0 nm or more. When the lower limit value of the average particle size of the hexagonal ferrite particles is 11.0 nm or more, the dispersibility of the hexagonal ferrite particles is further improved, and more excellent electromagnetic conversion characteristics (for example, SNR) can be obtained.

In a case where the ferrite particles contain hexagonal ferrite particles, an average aspect ratio of the hexagonal ferrite particles is preferably 1.0 or more and 3.0 or less, more preferably 1.5 or more and 2.8 or less, and still more preferably 1.8 or more and 2.7 or less. When the average aspect ratio of the hexagonal ferrite particles is within the range of 1.0 or more and 3.0 or less, aggregation of the hexagonal ferrite particles can be suppressed. Furthermore, when the hexagonal ferrite particles are vertically oriented in a process of forming the magnetic layer 43, resistance applied to the ferrite particles can be suppressed. Therefore, vertical orientation of the hexagonal ferrite particles can be improved.

In a case where the ferrite particles contain hexagonal ferrite particles, the average particle size and the average aspect ratio of the hexagonal ferrite particles are obtained as follows. First, the magnetic tape MT accommodated in the cartridge 10 is unwound, and the magnetic tape MT is cut out at a position of 30 m to 40 m in the longitudinal direction from one end on the outer peripheral side of the magnetic tape MT. Subsequently, the magnetic tape MT to be measured is processed into a thin piece by an FIB method or the like. In a case where the FIB method is used, formation of a carbon layer and a tungsten layer as protective films is performed as pre-processing for observing a TEM image of a cross section described below. The carbon layer is formed on a surface on the magnetic layer 43 side and a surface on the back layer 44 side of the magnetic tape MT by a vapor deposition method, and then the tungsten layer is further formed on the surface of the magnetic layer 43 by a vapor deposition method or a sputtering method. The thinning is performed in a length direction (longitudinal direction) of the magnetic tape MT. That is, a cross section parallel to both the longitudinal direction and the thickness direction of the magnetic tape MT is formed by the thinning.

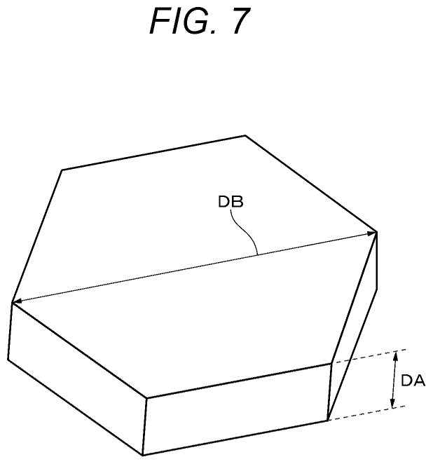

Using a transmission electron microscope (H-9500 manufactured by Hitachi High-Technologies Corporation), the cross section described above of the obtained thin piece sample is observed at an acceleration voltage of 200 kV and a total magnification of 500,000 times so that the entire magnetic layer 43 is included in the thickness direction of the magnetic layer 43, and a TEM image is captured. As the TEM image, the number of sheets capable of extracting fifty particles capable of measuring a plate diameter DB and a plate thickness DA (see FIG. 7) illustrated below is prepared.

In the present specification, as for the size of the hexagonal ferrite particles (hereinafter, referred to as “particle size”), in a case where the shape of the particles observed in the TEM image described above is a plate shape or a columnar shape (however, the thickness or height is smaller than the major axis of the plate surface or the bottom surface) as illustrated in FIG. 7, the major axis of the plate surface or the bottom surface is taken as the value of the plate diameter DB. The thickness or height of the particles observed in the TEM image described above is defined as the value of the plate thickness DA. In a case where a thickness or a height of a particle is not constant within one particle observed in the TEM image, the thickness or height of the maximum particle is taken as the plate thickness DA.

Next, fifty particles extracted from the captured TEM image are selected on the basis of the following criteria. A particle whose part of the particle protrudes outside the field of view of the TEM image is not measured, and a particle whose outline is clear and which exists in isolation is measured. In a case where particles overlap, each particle is to be measured as a single particle when the boundary between the particles is clear and the entire shape of each particle can be determined, but a particle in which the boundary is not clear and the entire shape of the particle cannot be determined is not to be measured as the shape of the particle cannot be determined.

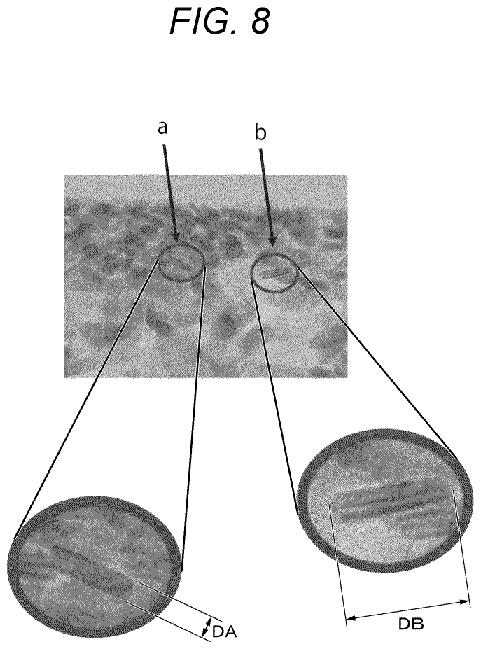

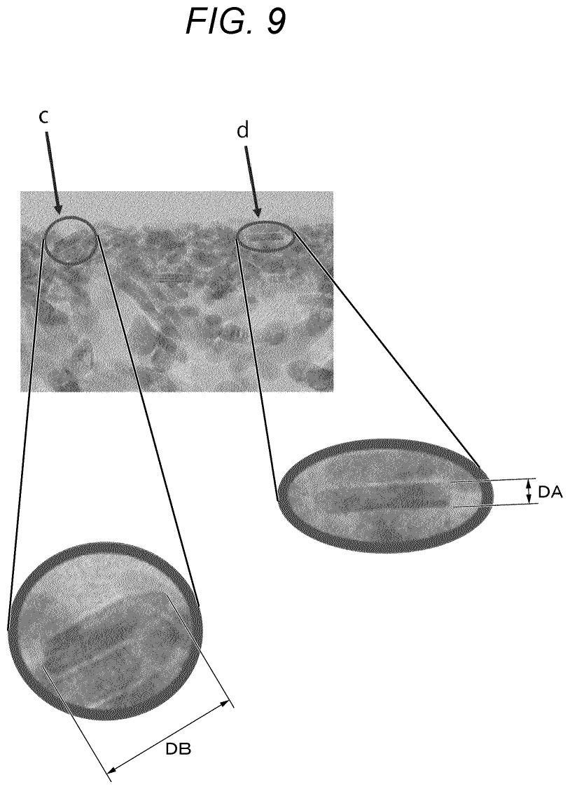

FIGS. 8 and 9 illustrate a first example and a second example of the TEM image, respectively. In FIGS. 8 and 9, for example, the particles indicated by arrows a and d are selected because the plate thickness (thickness or height of the particles) DA of the particles can be clearly confirmed. The plate thickness DA of each of the selected 50 particles is measured. The plate thicknesses DA thus obtained are simply averaged (arithmetically averaged) to obtain an average plate thickness DAₐᵥₑ. The average plate thickness DAₐᵥₑ is an average particle plate thickness. Subsequently, the plate diameter DB of each particle is measured. In order to measure the plate diameter DB of the particle, fifty particles for which the plate diameter DB of the particle can be clearly confirmed are selected from the captured TEM image. For example, in FIGS. 8 and 9, for example, the particles indicated by arrows b and c are selected because the plate diameter DB of the particles can be clearly confirmed. The plate diameter DB of each of the selected 50 particles is measured. The plate diameters DB thus obtained are simply averaged (arithmetically averaged) to obtain an average plate diameter DBₐᵥₑ. The average plate diameter DBₐᵥₑ is an average particle size. Then, an average aspect ratio (DBₐᵥₑ/DAₐᵥₑ) of the particle is obtained from the average plate thickness DAₐᵥₑ and the average plate diameter DBₐᵥₑ.

In a case where the ferrite particles contain hexagonal ferrite particles, an upper limit value of an average particle surface area Sₐᵥₑ of the hexagonal ferrite particles is preferably 900 nm² or less, more preferably 800 nm² or less, and still more preferably 700 nm² or less. When the upper limit value of the average particle surface area Sₐᵥₑ of the hexagonal ferrite particles is 900 nm² or less, a similar effect to a case where the average particle size of the ferrite particles is 18.0 nm or less can be obtained.

In a case where the ferrite particles contain hexagonal ferrite particles, a lower limit value of the average particle surface area Sₐᵥₑ of the hexagonal ferrite particles is preferably 280 nm² or more, more preferably 350 nm² or more, and still more preferably 400 nm² or more. When the lower limit value of the average particle surface area Sₐᵥₑ of the hexagonal ferrite particles is 280 nm² or more, a similar effect to a case where the average particle size of the hexagonal ferrite particles is 11.0 nm or more can be obtained.

The average particle surface area Sₐᵥₑ of the hexagonal ferrite particles is obtained as follows. First, the average plate thickness DAₐᵥₑ and the average plate diameter DBₐᵥₑ are obtained in a similar manner to the method of measuring the average particle size of the hexagonal ferrite particles described above. Next, the average particle surface area Sₐᵥₑ of the hexagonal ferrite particles is obtained by the following formula.

$${S}_{ave} = \frac{3 \sqrt{3}}{8} \times {( {DB}_{ave} )}^{2} \times 2 + \frac{{DB}_{ave}}{2} \times {DA}_{ave} \times 6 \qquad [ Mathematical formula 1 ]$$

In a case where the ferrite particles contain hexagonal ferrite particles, an upper limit value of an average particle volume Vₐᵥₑ of the hexagonal ferrite particles is preferably 1400 nm³ or less, more preferably 1200 mm³ or less, and still more preferably 1000 nm³ or less. In a case where the average particle volume Vₐᵥₑ Of the hexagonal ferrite particles is 1400 nm³ or less, an effect similar to that in a case where the average particle size of the hexagonal ferrite particles is 18.0 nm or less can be obtained.

In a case where the ferrite particles contain hexagonal ferrite particles, a lower limit value of the average particle volume Vₐᵥₑ of the hexagonal ferrite particles is preferably 400 nm³ or more, more preferably 500 nm³ or more, and still more preferably 600 nm³ or more. When the average particle volume Vₐᵥₑ of the hexagonal ferrite particles is 400 nm³ or more, an effect similar to that in a case where the average particle size of the hexagonal ferrite particles is 11.0 nm or more can be obtained.

The average particle volume Vₐᵥₑ of the hexagonal ferrite particles is obtained as follows. First, the average plate thickness DAₐᵥₑ and the average plate diameter DBₐᵥₑ are determined in the same manner as the method for measuring the average particle size of the hexagonal ferrite particles described above. Next, the average particle volume Vₐᵥₑ of the hexagonal ferrite particles is obtained by the following formula.

$${V}_{ave} = \frac{3 \sqrt{3}}{8} \times {( {DB}_{ave} )}^{2} \times {DA}_{ave} \qquad [ Mathematical formula 2 ]$$

In a case where the ferrite particles contain hexagonal ferrite particles, a ratio R_{V/S} (=Vₐᵥₑ/Sₐᵥₑ) of the average particle volume Vₐᵥₑ of the hexagonal ferrite particles to the average particle surface area Sₐᵥₑ of the hexagonal ferrite particles is preferably 1.8 or less, more preferably 1.7 or less, and still more preferably 1.6 or less. When the ratio R_{V/S} is 1.8 or less, a similar effect to the case where the average particle size of the hexagonal ferrite particles is 18.0 nm or less can be obtained.

The ratio R_{V/S} of the hexagonal ferrite particles is obtained as follows. First, the average particle surface area Sₐᵥₑ of the hexagonal ferrite particles and the average particle volume Vₐᵥₑ of the hexagonal ferrite particles are obtained. The method of measuring the average particle surface area Sₐᵥₑ and the average particle volume Vₐᵥₑ is as described above. Next, the ratio R_{V/S}=Vₐᵥₑ/Sₐᵥₑ is obtained using the average particle surface area Sₐᵥₑ and the average particle volume Vₐᵥₑ.

### (ε-Iron Oxide Particles)

The ε-iron oxide particles are hard magnetic particles capable of obtaining a high coercive force even with fine particles. The ε-iron oxide particles have a spherical shape or a cubic shape. In the present specification, the spherical shape includes a substantially spherical shape. Furthermore, the cubic shape includes a substantially cubic shape. Since the ε-iron oxide particles have the shape as described above, in a case where the ferrite particles contain the ε-iron oxide particles, the contact area between the particles in the thickness direction of the magnetic tape MT can be reduced and aggregation of the particles can be suppressed as compared with a case where the ferrite particles contain hexagonal ferrite particles having a plate shape such as a hexagonal plate shape or a columnar shape such as a hexagonal columnar shape. Therefore, dispersibility of the ferrite particles is increased, and more excellent electromagnetic conversion characteristics (for example, SNR) can be obtained.

The ε-iron oxide particles may have a structure of composite particles. More specifically, the ε-iron oxide particle includes an ε-iron oxide portion and a portion having soft magnetism or a portion having magnetism in which a saturation magnetization amount σs is higher than that of ε-iron oxide and a coercive force Hc is smaller than that of ε-iron oxide (hereinafter, referred to as a “portion having soft magnetism or the like”).

The ε-iron oxide portion contains ε-iron oxide. The ε-iron oxide contained in the ε-iron oxide portion preferably includes an ε-Fe₂O₃ crystal as a main phase, and more preferably includes a single-phase ε-Fe₂O₃.

The portion having soft magnetism or the like is in contact with at least a part of the ε-iron oxide portion. Specifically, the portion having soft magnetism or the like may partially cover the ε-iron oxide portion, and may partially cover an entire periphery of the ε-iron oxide portion.

The portion having soft magnetism (portion having magnetism in which the saturation magnetization amount σs is higher than that of ε-iron oxide and the coercive force Hc is smaller than that of ε-iron oxide) contains, for example, a soft magnetic material such as α-Fe, a Ni—Fe alloy, an Fe—Si—Al alloy, or the like. α-Fe may be obtained by reducing the ε-iron oxide contained in the ε-iron oxide portion.

Furthermore, the portion having soft magnetism may contain, for example, Fe₃O₄, γ-Fe₂O₃, spinel ferrite, or the like.

The ε-iron oxide particle includes the portion having soft magnetism described above or the like, such that the coercive force Hc of the ε-iron oxide particles (composite particles) as a whole can be adjusted to a coercive force Hc suitable for recording while maintaining the coercive force Hc of the ε-iron oxide portion alone at a large value in order to ensure thermal stability.

The ε-iron oxide particles may contain an additive instead of the structure of the composite particles described above, or may have the structure of the composite particles and may contain an additive as well. In this case, a part of Fe of the ε-iron oxide particles is replaced with an additive. Since the coercive force Hc of the entire ε-iron oxide particles can be adjusted to the coercive force Hc suitable for recording also when the ε-iron oxide particle contains the additive, the ease of recording can be improved. The additive is a metal element other than iron, preferably a trivalent metal element, more preferably at least one type selected from the group consisting of Al, Ga, and In, and still more preferably at least one type selected from the group consisting of Al and Ga.

Specifically, the ε-iron oxide containing the additive is an ε-Fe₂₋ₓMₓO₃ crystal (where M is a metal element other than iron, preferably a trivalent metal element, more preferably at least one type selected from the group consisting of Al, Ga, and In, and still more preferably at least one type selected from the group consisting of Al and Ga, and x is, for example, 0<x<1.).

In a case where the ferrite particles contain ε-iron oxide particles, an upper limit value of the average particle size of the ε-iron oxide particles is preferably 14.0 nm or less, more preferably 13.0 nm or less, and still more preferably 12.0 nm or less. When the upper limit value of the average particle size of the ε-iron oxide particles is 14.0 nm or less, more excellent electromagnetic conversion characteristics (for example, SNR) can be obtained in the magnetic tape MT having a high recording density.

In a case where the ferrite particles contain ε-iron oxide particles, a lower limit value of the average particle size of the ε-iron oxide particles is preferably 9.0 nm or more, more preferably 9.5 nm or more, and still more preferably 10.0 nm or more. When the lower limit value of the average particle size of the ε-iron oxide particles is 9.0 nm or more, dispersibility of the ε-iron oxide particles is further improved, and more excellent electromagnetic conversion characteristics (for example, SNR) can be obtained.

In a case where the ferrite particles contain ε-iron oxide particles, an average aspect ratio of the ε-iron oxide particles is preferably 1.0 or more and 3.0 or less, more preferably 1.0 or more and 2.5 or less, still more preferably 1.0 or more and 2.1 or less, and particularly preferably 1.0 or more and 1.8 or less. When the average aspect ratio of the ε-iron oxide particles is in the range of 1.0 or more and 3.0 or less, aggregation of the ε-iron oxide particles can be suppressed. Furthermore, when the ε-iron oxide particles are vertically oriented in a process of forming the magnetic layer 43, resistance applied to the ε-iron oxide particles can be suppressed. Therefore, vertical orientation of the ε-iron oxide particles can be improved.

In a case where the ferrite particles contain ε-iron oxide particles, the average particle size and the average aspect ratio of the ε-iron oxide particles are obtained as follows. First, the magnetic tape MT accommodated in the cartridge 10 is unwound, and the magnetic tape MT is cut out at a position of 30 m to 40 m in the longitudinal direction from one end on the outer peripheral side of the magnetic tape MT. Subsequently, the magnetic tape MT to be measured is processed by a focused ion beam (FIB) method or the like to be thinned. In a case where the FIB method is used, a carbon layer and a tungsten layer are formed as protective layers as a pre-treatment for observing a TEM image of a cross section described later. The carbon layer is formed on a surface on the magnetic layer 43 side and a surface on the back layer 44 side of the magnetic tape MT by a vapor deposition method, and then the tungsten layer is further formed on the surface of the magnetic layer 43 by a vapor deposition method or a sputtering method. The thinning is performed in the length direction (longitudinal direction) of the magnetic tape MT. That is, a cross section parallel to both the longitudinal direction and the thickness direction of the magnetic tape MT is formed by the thinning.

Using a transmission electron microscope (H-9500 manufactured by Hitachi High-Technologies Corporation), the cross section described above of the obtained thin piece sample is observed at an acceleration voltage of 200 kV and a total magnification of 500,000 times so that the entire magnetic layer 43 is included in the thickness direction of the magnetic layer 43, and a TEM image is captured. Next, 50 particles whose shapes can be clearly confirmed are selected from the captured TEM image, and a long axis length DL and a short axis length DS of each particle are measured. Here, the long axis length DL means the largest one of the distances between two parallel lines drawn from all angles so as to be in contact with a contour of each particle (so-called maximum Feret's diameter). Meanwhile, the short axis length DS means the largest one of the lengths of a particle in a direction orthogonal to the long axis (DL) of the particle. Subsequently, the measured long axis lengths DL of the 50 particles are simply averaged (arithmetically averaged) to obtain an average long axis length DLₐᵥₑ. The average long axis length DLₐᵥₑ obtained as described above is defined as the average particle size of the ε-iron oxide particles. Furthermore, the measured short axis lengths DSs of the 50 particles are simply averaged (arithmetically averaged) to determine an average short axis length DSₐᵥₑ. Then, an average aspect ratio (DLₐᵥₑ/DSₐᵥₑ) of the particles is obtained from the average long axis length DLₐᵥₑ and the average short axis length DSₐᵥₑ.

In a case where the ferrite particles contain ε-iron oxide particles, an upper limit value of the average particle surface area Sₐᵥₑ of the ε-iron oxide particles is preferably 650 nm² or less, more preferably 550 nm² or less, and still more preferably 500 nm² or less. When the upper limit value of the average particle surface area Sₐᵥₑ of the ε-iron oxide particles is 650 nm² or less, a similar effect to a case where the ε-iron oxide particle size is 14.0 nm or less can be obtained.

In a case where the ferrite particles contain ε-iron oxide particles, a lower limit value of the average particle surface area Sₐᵥₑ of the ε-iron oxide particles is preferably 250 nm² or more, more preferably 280 nm² or more, and still more preferably 300 nm² or more. When the lower limit value of the average particle surface area Sₐᵥₑ of the ε-iron oxide particles is 250 nm² or more, a similar effect to a case where the average particle size of the ε-iron oxide particles is 9.0 nm or more can be obtained.

Assuming that each of the ε-iron oxide particles has a spherical shape, the average particle surface area Sₐᵥₑ of the ε-iron oxide particles is obtained as follows. First, an average long axis length DLₐᵥₑ is obtained in a manner similar to the method of measuring the average particle size of the ε-iron oxide particles described above. Next, the average particle surface area Sₐᵥₑ of the ε-iron oxide particles is obtained by the following formula.

$${S}_{a v e} = π \times {DL}_{a v e}^{2}$$

In a case where the ferrite particles contain ε-iron oxide particles, an upper limit value of the average particle volume Vₐᵥₑ of the ε-iron oxide particles is preferably 1400 nm³ or less, more preferably 1200 nm³ or less, and still more preferably 1000 nm³ or less. When the average particle volume Vₐᵥₑ of the ε-iron oxide particles is 1400 nm³ or less, a similar effect to the case where the average particle size of the ε-iron oxide particles is 14.0 nm or less can be obtained.

In a case where the ferrite particles contain E-iron oxide particles, a lower limit value of the average particle volume Vₐᵥₑ of the ε-iron oxide particles is preferably 400 nm³ or more, more preferably 500 nm³ or more, and still more preferably 600 nm³ or more. When the average particle volume Vₐᵥₑ of the ε-iron oxide particles is 400 nm³ or more, a similar effect to the case where the average particle size of the ε-iron oxide particles is 9.0 nm or more can be obtained.

Assuming that each of the ε-iron oxide particles has a spherical shape, the average particle volume of the ε-iron oxide particles is obtained as follows. First, an average long axis length DLₐᵥₑ is obtained in a manner similar to the method of measuring the average particle size of the ε-iron oxide particles described above. Next, the average particle volume Vₐᵥₑ of the ε-iron oxide particles is obtained by the following formula.

$${V}_{ave} = ( π / 6 ) {DL}_{a v e}^{3}$$

### (Binder)

A binder contains, for example, a thermoplastic resin. The binder may further contain a thermosetting resin, a reactive resin, or the like.

The thermoplastic resin contains, for example, a first thermoplastic resin containing a chlorine atom (first binder) and a second thermoplastic resin containing a nitrogen atom (second binder). More specifically, for example, the thermoplastic resin contains a vinyl chloride-based resin and a urethane-based resin. In the present specification, the vinyl chloride-based resin means a polymer containing a structural unit derived from vinyl chloride. More specifically, for example, the vinyl chloride-based resin means a homopolymer of vinyl chloride, a polymer of vinyl chloride and a comonomer copolymerizable therewith, and a mixture of these polymers.

The vinyl chloride-based resin includes, for example, at least one type selected from the group consisting of vinyl chloride, a vinyl chloride-vinyl acetate copolymer, a vinyl chloride-vinylidene chloride copolymer, a vinyl chloride-acrylonitrile copolymer, an acrylic acid ester-vinyl chloride-vinylidene chloride copolymer, and a methacrylic acid ester-vinyl chloride copolymer.

The urethane-based resin means a resin containing a urethane bond in at least a part of a molecular chain constituting the resin, and may be a urethane resin or a copolymer containing a urethane bond in a part of a molecular chain. The urethane-based resin may be obtained, for example, by reacting a polyisocyanate with a polyol. Alternatively, the urethane-based resin may be obtained, for example, by reacting a polyester with a polyol. In the present specification, the urethane-based resin includes those obtained by reaction with a curing agent.

The polyisocyanate includes, for example, at least one selected from the group consisting of diphenylmethane diisocyanate (MDI), tolylene diisocyanate (TDI), xylylene diisocyanate (XDI), 1,5-pentamethylene diisocyanate (PDI), hexamethylene diisocyanate (HDI), isophorone diisocyanate (IPDI), and the like. In the present specification, the polyisocyanate means a compound having two or more isocyanate groups in the molecule. The polyisocyanate may be a polyisocyanate contained in the curing agent.

As the polyol, any suitable polyol can be adopted as long as it is a polyol having two or more OH groups. The polyol includes, for example, at least one selected from the group consisting of a polyol having two OH groups (diol), a polyol having three OH groups (triol), a polyol having four OH groups (tetraol), a polyol having five OH groups (pentaol), and a polyol having six OH groups (hexaol). Specifically, the polyol includes, for example, at least one selected from the group consisting of a polyester-based polyol, a polyether-based polyol, a polycarbonate-based polyol, a polyesteramide-based polyol, an acrylate-based polyol, and the like.

The polyester contains, for example, at least one type selected from the group consisting of a phthalic acid-based polyester and an aliphatic polyester.

The thermoplastic resin may further contain a thermoplastic resin other than the vinyl chloride-based resin and the urethane-based resin. Such a thermoplastic resin contains, for example, at least one type selected from the group consisting of vinyl acetate, an acrylic acid ester-acrylonitrile copolymer, an acrylic acid ester-acrylonitrile copolymer, an acrylic acid ester-vinylidene chloride copolymer, a methacrylic acid ester-vinylidene chloride copolymer, a methacrylic acid ester-ethylene copolymer, polyvinyl fluoride, a vinylidene chloride-acrylonitrile copolymer, an acrylonitrile-butadiene copolymer, a polyamide resin, polyvinyl butyral, a cellulose derivative (cellulose acetate butyrate, cellulose diacetate, cellulose triacetate, cellulose propionate, or nitrocellulose), a styrene-butadiene copolymer, a polyester resin, an amino resin, and synthetic rubber.

The thermosetting resin contains, for example, at least one type selected from the group consisting of a phenol resin, an epoxy resin, a polyurethane curable resin, a urea resin, a melamine resin, an alkyd resin, a silicone resin, a polyamine resin, and a urea formaldehyde resin.

For the purpose of improving the dispersibility of the ferrite particles, polar functional groups such as —SO₃M, —OSO₃M, —COOM, P═O(OM)₂ (where M in the formulas represents a hydrogen atom or an alkali metal such as lithium, potassium, or sodium), a side chain type amine having an end group represented by —NR1R2 or —NR1R2R3⁺X⁻, a main chain type amine represented by >NR1R2⁺X⁻ (where R1, R2, and R3 in the formulas represent a hydrogen atom or a hydrocarbon group, and X⁻ represents a halogen element ion such as fluorine, chlorine, bromine, or iodine, an inorganic ion, or an organic ion), —OH, —SH, —CN, and an epoxy group may be introduced into all the binders described above. An amount of these polar functional groups to be introduced into the binder is preferably 10⁻¹ mol/g or more and 10⁻⁸ mol/g or less, and more preferably 10⁻² mol/g or more and 10⁻⁶ mol/g or less.

### (Acidic Compound)

The acidic compound may contain, for example, at least one type selected from the group consisting of a dispersant and an additive other than the dispersant. The binder may be an acidic compound. The dispersant may be a compound having an action of assisting dispersion of ferrite particles by interaction with the ferrite particles in the magnetic layer forming coating material. The acidic compound may contain one or both of a monobasic acid and a polybasic acid. The acidic compound may contain one or both of an organic acid and an inorganic acid. The dispersant may be, for example, a surfactant, a polymeric dispersant or a thickener.

The acidic compound may be configured to be adsorbable on a surface of the ferrite particle contained in the magnetic layer 43. In this case, a part of the acidic compound may be adsorbed on the surfaces of the ferrite particles contained in the magnetic layer 43, and the remaining acidic oxide may be present in the magnetic layer 43 without being adsorbed on the surfaces of the ferrite particles contained in the magnetic layer 43. When moisture is diffused into the magnetic layer 43 by long-term storage or the like, the acidic compound not adsorbed on the surfaces of the ferrite particles is dissolved in the moisture and easily generates an acidic aqueous solution. For this reason, the acidic compound not adsorbed on the surfaces of the ferrite particles easily accelerates the deterioration of the ferrite particles, and there is a possibility that the magnetic characteristics (for example, saturation magnetization Ms) are deteriorated. Therefore, the numerical definition of the reduction rate of the saturation magnetization Ms is particularly effective in a case where an acidic compound not adsorbed on the surfaces of the ferrite particles is present in the magnetic layer 43.

The acidic compound has, for example, at least one acidic functional group. The acidic functional group may be an acidic adsorption group that can be adsorbed to the ferrite particle surface by interaction with the ferrite particle. The at least one acidic functional group contains, for example, at least one type selected from the group consisting of a phosphate group, a carboxyl group, a sulfonic acid group, and the like.

The acidic compound may contain, for example, at least one type selected from the group consisting of a phosphonic acid-based compound, a carboxylic acid-based compound, a sulfonic acid-based compound, and the like. More specifically, the acidic compound contains, for example, at least one type selected from the group consisting of phenylphosphonic acid, benzoic acid, naphthoic acid, hydroxybenzoic acid, isophthalic acid, oleic acid, cyclohexanecarboxylic acid, adipic acid, citric acid, and the like. The naphthoic acid contains, for example, 1-naphthoic acid. The hydroxybenzoic acid contains, for example, 4-hydroxybenzoic acid.

The phosphonic acid-based compound contains, for example, at least one type selected from the group consisting of aromatic phosphonic acid-based compounds, chain aliphatic phosphonic acid-based compounds, cyclic aliphatic phosphonic acid-based compounds, and the like. The phosphonic acid-based compound may contain, for example, one or both of a monovalent phosphonic acid-based compound and a polyvalent phosphonic acid-based compound. The aromatic phosphonic acid-based compound may contain, for example, phenylphosphonic acid or the like.

The carboxylic acid-based compound contains, for example, at least one type selected from the group consisting of aromatic carboxylic acid-based compounds, chain aliphatic carboxylic acid-based compounds, and cyclic aliphatic carboxylic acid-based compounds. The carboxylic acid-based compound may contain, for example, one or both of a monovalent carboxylic acid-based compound and a polyvalent carboxylic acid-based compound. The aromatic carboxylic acid contains, for example, at least one type selected from the group consisting of benzoic acid, naphthoic acid, hydroxybenzoic acid, isophthalic acid, and the like. The chain aliphatic carboxylic acid contains, for example, at least one type selected from the group consisting of adipic acid, citric acid, oleic acid, and the like. The cycloaliphatic carboxylic acid contains, for example, cyclohexanecarboxylic acid or the like.

As the carboxylic acid-based compound, for example, fatty acids having 12 to 18 carbon atoms [RCOOH (R is an alkyl group or an alkenyl group having 11 to 17 carbon atoms)] such as caprylic acid, capric acid, lauric acid, myristic acid, palmitic acid, stearic acid, behenic acid, oleic acid, elaidic acid, linoleic acid, linolenic acid, and stearolic acid; metal soap including alkali metal or alkaline earth metal of the fatty acid; Fluorine-containing compound of the fatty acid ester; an amide of the fatty acid; polyalkylene oxide alkyl phosphate ester; lecithin; trialkylpolyolefinoxy quaternary ammonium salt (alkyl has 1 to 5 carbon atoms, olefin is ethylene, propylene, and the like.); phenylphosphenic acid; Copper phthalocyanine; and the like can also be used. These may be used alone or in combination.

The sulfonic acid-based compound contains, for example, at least one type selected from the group consisting of aromatic sulfonic acid-based compounds, chain aliphatic sulfonic acid-based compounds, and cyclic aliphatic sulfonic acid-based compounds. The sulfonic acid-based compound may contain, for example, one or both of a monovalent sulfonic acid-based compound and a polyvalent sulfonic acid-based compound.

An acid dissociation constant (pKa) of the acidic compound is, for example, 5.0 or less, 4.9 or less, 4.8 or less, 4.7 or less, 4.6 or less, 4.5 or less, 4.4 or less, 4.3 or less, 4.2 or less, 4.1 or less, 4.0 or less, 3.9 or less, 3.8 or less, 3.7 or less, 3.6 or less, or 3.5 or less.

The acid dissociation constant (pKa) is a parameter indicating the degree of dissociation of an acid. When the ionization constant of an acid is Ka, the acid dissociation constant is defined by pKa=−log₁₀ Ka. The smaller the value of the acid dissociation constant (pKa), the stronger the acidic compound is as an acid. In the present disclosure, the acid dissociation constant (pKa) is measured by potentiometric titration (JIS K 0070:1992) at an environmental temperature of 25° C.

As described above, when the acid dissociation constant (pKa) of the acidic compound is 5.0 or less, hydrogen ions are likely to be released from the acidic compound. For this reason, an acidic aqueous solution is easily generated in the magnetic layer 43, and the deterioration of the ferrite particles is easily promoted. In a case where the average particle volume Vₐᵥₑ of the ferrite particles is 1400 nm³ or less, the deterioration of the ferrite particles is particularly likely to be promoted. Therefore, the numerical definition of the reduction rate of the saturation magnetization Ms is particularly effective in a case where the acid dissociation constant (pKa) of the acidic compound is 5.0 or less.

The acidic compound may have one acid dissociation constant (pKa) or a plurality of acid dissociation constants (pKa). In a case where the acidic compound has a plurality of acid dissociation constants (pKa), the acid dissociation constant (pKa) of the acidic compound being 5 or less means that the smallest acid dissociation constant (pKa) among the plurality of acid dissociation constants (pKa) of the acidic compound is 5 or less.

### (Conductive Particles)

Some of the conductive particles contained in the magnetic layer 43 may protrude from the magnetic surface to form a plurality of protrusions. Since the plurality of protrusions includes conductive particles, electric resistance of the magnetic surface can be reduced, and charging of the magnetic surface can be suppressed. Furthermore, dynamic friction between the head unit 56 and the magnetic surface can be reduced when the magnetic tape MT travels.

The conductive particles are preferably antistatic agents and solid lubricants. The conductive particles are preferably particles containing carbon. As the carbon-containing particles, for example, at least one type selected from the group consisting of carbon particles and hybrid particles can be used, and it is preferable to use carbon particles. An average primary particle size of the conductive particles is preferably 100.0 nm or less. When the average primary particle size of the conductive particles is 100.0 nm or less, the content of particles excessively large with respect to the thickness of the magnetic layer 43 is suppressed even in a case where the conductive particles are particles (for example, carbon black or the like) having a large particle size distribution.

As the carbon particles, for example, one or more selected from the group consisting of carbon black, acetylene black, Ketjen black, carbon nanotubes, and graphene can be used, and among these carbon particles, carbon black is preferably used. As the carbon black, for example, SEAST TA manufactured by Tokai Carbon, Asahi #15 and #15HS manufactured by Asahi Carbon Co., Ltd., and the like can be used.

The hybrid particles contain carbon and a material other than carbon. The material other than carbon is, for example, an organic material or an inorganic material. The hybrid particles may be hybrid particles in which carbon is attached to a surface of the inorganic particle. Specifically, for example, hybrid carbons in which carbon is attached to a surface of silica particles may be used.

### (Abrasive Particles)

Some of the abrasive particles contained in the magnetic layer 43 may protrude from the magnetic surface to form a plurality of protrusions. When the head unit 56 and the magnetic tape MT slide, the protrusions formed by the abrasive particles are able to come into contact with the head unit 56.

A lower limit value of the Mohs hardness of the abrasive particles is preferably 7.0 or more, more preferably 7.5 or more, still more preferably 8.0 or more, and particularly preferably 8.5 or more from a viewpoint of suppressing deformation due to contact with the head unit 56. An upper limit value of the Mohs hardness of the abrasive particles is preferably 9.5 or less from a viewpoint of suppressing wear of the head unit 56.

The abrasive particles are preferably inorganic particles. Examples of the inorganic particle includes α-alumina having an a conversion rate of 90% or more, β-alumina, γ-alumina, silicon carbide, chromium oxide, cerium oxide, α-iron oxide, corundum, silicon nitride, titanium carbide, titanium oxide, silicon dioxide, tin oxide, magnesium oxide, tungsten oxide, zirconium oxide, boron nitride, zinc oxide, calcium carbonate, calcium sulfate, barium sulfate, molybdenum disulfide, acicular α-iron oxide prepared by subjecting a raw material of magnetic iron oxide to dehydration and an annealing treatment, materials obtained by subjecting these to a surface treatment with aluminum and/or silica, as required, a diamond powder, and the like. As the inorganic particles, alumina particles such as α-alumina, β-alumina, and γ-alumina, and silicon carbide are preferably used. Although the abrasive particles may have any shape such as a needle shape, a spherical shape, or a dice shape, those having a corner in a part of the shape are preferable because they have high abrasiveness.

### (Lubricant)

The lubricant contains, for example, at least one type selected from fatty acid and fatty acid ester, preferably both fatty acid and fatty acid ester. The fact that the magnetic layer 43 contains a lubricant, in particular, the fact that the magnetic layer 43 contains both fatty acid and fatty acid ester contributes to improvement of traveling stability of the magnetic tape MT. More particularly, since the magnetic layer 43 contains a lubricant and has pores, good traveling stability is achieved. The improvement of the traveling stability is considered to be because the dynamic friction coefficient of the magnetic layer 43 side surface of the magnetic tape MT is adjusted to a value suitable for travel of the magnetic tape MT by the lubricant described above.

The fatty acid may be preferably a compound represented by the following general Formula (1) or (2). For example, one or both of the compound represented by the following general Formula (1) and the compound represented by the general Formula (2) may be contained as the fatty acid.

Furthermore, the fatty acid ester may be preferably a compound represented by the following general Formula (3), (4) or (5). For example, the fatty acid ester may contain one, two or three types of the compounds represented by the following general Formula (3), the compounds represented by general Formula (4) and the compounds represented by general Formula (5).

With the lubricant containing either one or both of the compounds represented by general Formula (1) and the compounds represented by general Formula (2), and one, two or three types of the compounds represented by general Formula (3), the compounds represented by general Formula (4) and the compounds represented by general Formula (5), an increase in dynamic friction coefficient due to repeated recording or reproduction on the magnetic tape MT can be suppressed.

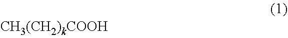

(where, in general Formula (1), k is an integer selected from a range of 14 or more and 22 or less, and more preferably a range of 14 or more and 18 or less.)

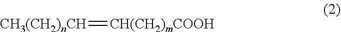

(where, in general Formula (2), the sum of n and m is an integer selected from a range of 12 or more and 20 or less, and more preferably a range of 14 or more and 18 or less.)

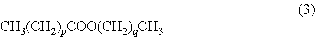

(Here, in general Formula (3), p is an integer selected from a range of 14 or more and 22 or less, and more preferably a range of 14 or more and 18 or less, and q is an integer selected from a range of 2 or more and 5 or less, and more preferably a range of 2 or more and 4 or less.)

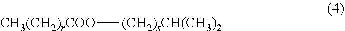

(where, in general Formula (4), r is an integer selected from a range of 14 or more and 22 or less, and s is an integer selected from a range of 1 or more and 3 or less.)

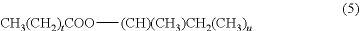

(where, in general Formula (5), t is an integer selected from a range of 14 or more and 22 or less, and u is an integer selected from a range of 1 or more and 3 or less.)

### (Antistatic Agent)

The antistatic agent may further contain at least one type selected from the group consisting of a natural surfactant, a nonionic surfactant, a cationic surfactant, and the like. The conductive particles described above may function as an antistatic agent.

### (Curing Agent)

The curing agent contains, for example, polyisocyanate. The polyisocyanate may contain, for example, diphenylmethane diisocyanate (MDI), tolylene diisocyanate (TDI), xylylene diisocyanate (XDI), 1,5-pentamethylene diisocyanate (PDI), hexamethylene diisocyanate (HDI), isophorone diisocyanate (IPDI), or the like as an isocyanate source. The polyisocyanate may have a TMP adduct structure, an isocyanurate structure, a biuret structure, an allophanate structure, or the like.

Specifically, the polyisocyanate contains, for example, aromatic polyisocyanates such as an adduct of tolylene diisocyanate (TDI) and an active hydrogen compound, aliphatic polyisocyanates such as an adduct of hexamethylene diisocyanate (HMDI) and an active hydrogen compound, and the like. A weight average molecular weight of these polyisocyanates is desirably in a range of 100 or more and 3000 or less.

### (Rust-Preventive Agent)

Examples of the rust-preventive agent include phenols, naphthols, quinones, heterocyclic compounds containing a nitrogen atom, heterocyclic compounds containing an oxygen atom, heterocyclic compounds containing a sulfur atom, and the like.

### (Nonmagnetic Reinforcing Particle)

Examples of the nonmagnetic reinforcing particle include aluminum oxide (α, β, or γ alumina), chromium oxide, silicon oxide, diamond, garnet, emery, boron nitride, titanium carbide, silicon carbide, titanium carbide, titanium oxide (rutile type or anatase type titanium oxide), and the like.

### (Underlayer)

The underlayer 42 is configured to be able to relax the concavoconvex shape of the surface of the base 41 and adjust the concavoconvex shape of the magnetic surface. The underlayer 42 is, for example, a nonmagnetic layer including nonmagnetic particles and a binder. The underlayer 42 may contain an additive as necessary. The additive may further contain at least one type selected from the group consisting of a lubricant, an acidic compound, an antistatic agent, a curing agent, a rust-preventive agent, and the like.

An average thickness t₂ of the underlayer 42 is preferably 0.30 μm or more and 1.20 μm or less, more preferably 0.30 μm or more and 0.90 μm or less, and still more preferably 0.30 μm or more and 0.60 μm or less. Note that the average thickness t₂ of the underlayer 42 is obtained similarly to the average thickness t₁ of the magnetic layer 43. However, magnification of the TEM image is appropriately adjusted according to the thickness of the underlayer 42. When the average thickness t₂ of the underlayer 42 is 1.20 μm or less, stretchability of the magnetic tape MT due to an external force further increases, so that adjustment of the width of the magnetic tape MT by tension adjustment is further facilitated.

The underlayer 42 preferably includes the plurality of holes. Since the lubricant is stored in the plurality of holes, it is possible to further suppress a decrease in supply amount of the lubricant between the magnetic surface and the head unit 56 even after the repeated recording or reproduction (that is, even after the head unit 56 is brought into contact with the surface of the magnetic tape MT and repeatedly travels). Therefore, the increase in dynamic friction coefficient may be further suppressed. That is, more excellent traveling stability can be obtained.

### (Nonmagnetic Particle)

The nonmagnetic particles include, for example, at least one type of inorganic particles or organic particles. Furthermore, the nonmagnetic particles may be carbon particles such as carbon black. Note that one type of nonmagnetic particles may be used alone, or two or more types of nonmagnetic particles may be used in combination. The inorganic particles contain, for example, metal, metal oxide, metal carbonate, metal sulfate, metal nitride, metal carbide, metal sulfide and the like. A shape of the nonmagnetic particle may be, for example, various shapes such as a needle shape, a spherical shape, a cubic shape, a plate shape and the like, but is not limited these shapes.

### (Binder)

The binder and the lubricant are similar to that of the magnetic layer 43 described above.

### (Additive)

The lubricant, the acidic compound, the antistatic agent, the curing agent, and the rust-preventive agent may be similar to the lubricant, the acidic compound, the antistatic agent, the curing agent, and the rust-preventive agent contained in the magnetic layer 43, respectively. In a case where the underlayer 42 contains a lubricant, the underlayer 42 can supply the lubricant to the magnetic surface. In a case where the acidic compound contains a dispersant, the dispersant may be a compound having an action of assisting dispersion of nonmagnetic particles by interaction with the nonmagnetic particles in a nonmagnetic layer forming coating material.

### (Back Layer)

The back layer 44 contains, for example, a binder and nonmagnetic particles. The back layer 44 may further contain at least one type of additive selected from the group consisting of a lubricant, a curing agent, an antistatic agent, and the like, as necessary. The binder and the nonmagnetic particles are similar to those of the underlayer 42 described above. The curing agent and the antistatic agent are similar to those of the magnetic layer 43 described above.

An average particle size of the nonmagnetic particles is preferably 10.0 nm or more and 150.0 nm or less, and more preferably 15.0 nm or more and 110.0 nm or less. The average particle size of the nonmagnetic particles is obtained similarly to the average particle size of the ferrite particles described above. The nonmagnetic particles may also contain nonmagnetic particles having two or more particle size distributions.

An upper limit value of an average thickness of the back layer 44 is preferably 0.60 μm or less. When the upper limit value of the average thickness of the back layer 44 is 0.60 μm or less, the thicknesses of the underlayer 42 and the base 41 can be kept thick even in a case where the average thickness of the magnetic tape MT is 5.30 μm or less, so that the traveling stability of the magnetic tape MT in the recording/reproducing device can be maintained. A lower limit value of the average thickness of the back layer 44 is not particularly limited, and is, for example, 0.20 μm or more.

The average thickness t_{b} of the back layer 44 is obtained as follows. First, an average thickness t_{T} of the magnetic tape MT is measured. The method of measuring the average thickness t_{T} is as described in the following “Average thickness of magnetic tape”. Subsequently, the magnetic tape MT accommodated in the cartridge 10 is unwound, and the magnetic tape MT is cut out to a length of 250 mm at a position of 30 m to 40 m in the longitudinal direction from one end on the outer peripheral side of the magnetic tape MT, thereby preparing a sample. Next, the back layer 44 of the sample is removed with a solvent such as methyl ethyl ketone (MEK) or dilute hydrochloric acid. Next, the thickness of the sample is measured at five positions using a laser hologauge (LGH-110C) manufactured by Mitutoyo Corporation, and these measured values are simply averaged (arithmetically averaged) to calculate an average t_{B} [μm]. Thereafter, the average thickness t_{b} [μm] of the back layer 44 is obtained by the following formula. Note that the five measurement positions described above are randomly selected from the sample so as to be different positions in the longitudinal direction of the magnetic tape MT.

$${t}_{b} [ μm ] = {t}_{T} [ μm ] - {t}_{B} [ μm ]$$

### (Average Thickness of Magnetic Tape)

An upper limit value of the average thickness (average total thickness) t_{T} of the magnetic tape MT is preferably 5.30 μm or less, more preferably 5.10 μm or less, still more preferably 4.90 μm or less, and particularly preferably 4.70 μm or less. When the average thickness t_{T} of the magnetic tape MT is 5.30 μm or less, the recording capacity that can be recorded in one data cartridge can be increased as compared with a general magnetic tape. A lower limit value of the average thickness t_{T} of the magnetic tape MT is not particularly limited, and is, for example, 3.50 μm or more.

The average thickness t_{T} of the magnetic tape MT is obtained as follows. First, the magnetic tape MT accommodated in the cartridge 10 is unwound, and the magnetic tape MT is cut out to a length of 250 mm at a position of 30 m to 40 m in a longitudinal direction from one end on an outer peripheral side of the magnetic tape MT, thereby preparing a sample. Next, the thickness of the sample is measured at five positions using a laser hologauge (LGH-110C) manufactured by Mitutoyo Corporation as a measurement device, and these measured values are simply averaged (arithmetically averaged) to calculate the average thickness t_{T} [μm]. Note that the five measurement positions described above are randomly selected from the sample so as to be different positions in the longitudinal direction of the magnetic tape MT.

### (Reduction Rate of Saturation Magnetization Ms)

A reduction rate of the saturation magnetization Ms in an environment of a temperature of 60° C. and a humidity of 90 RH % is preferably 1.00 [%/8 weeks] or less, more preferably 0.40 [%/8 weeks] or less, and still more preferably 0.10 [%/8 weeks] or less, 0.05 [%/8 weeks] or less, or 0.02 [%/8 weeks] or less. The reduction rate of the saturation magnetization Ms can be set to a desired value, for example, by adjusting the conditions of the manufacturing process of the magnetic recording medium.

The reason why the reduction rate of the saturation magnetization Ms is preferably 1.00 [%/8 weeks] or less is as follows. A decrease in the saturation magnetization Ms means a decrease in thermal stability. In a case where the average particle volume Vₐᵥₑ of the ferrite particles contained in the magnetic layer 43 is 1400 nm³ or less, the reproduction signal at room temperature is likely to deteriorate due to slight deterioration of magnetic characteristics. Since the deterioration of the reproduction signal is easily affected by a component having low magnetic characteristics, when the magnetic characteristics of the entire magnetic powder deteriorate, a component that easily attenuates the reproduction output increases. When the reduction rate of the saturation magnetization Ms exceeds 1.00 [%/8 weeks], such a component is particularly likely to increase.

The numerical definition of the reduction rate of the saturation magnetization Ms is particularly effective in the magnetic layer 43 in which the average particle volume Vₐᵥₑ of the ferrite particles is 1400 nm³ or less. The reason for this is as follows. When moisture is diffused into the magnetic layer 43 by long-term storage or the like, an acidic compound in the magnetic layer 43 may be dissolved in the moisture to generate an acidic aqueous solution. This aqueous solution has a property of dissolving ferrite particles. When the average particle volume Vₐᵥₑ of the ferrite particles is 1400 nm³ or less, the ferrite particles are likely to be affected by an acidic aqueous solution because the specific surface area of the ferrite particles is large. Therefore, deterioration of the ferrite particles is particularly likely to be promoted, and there is a possibility that magnetic characteristics (for example, saturation magnetization Ms) are deteriorated.

In consideration of the above mechanism of deterioration of magnetic characteristics, in the magnetic layer 43 in which the average particle volume Vₐᵥₑ of the ferrite particles is 1400 nm³ or less, it is particularly effective to set the reduction rate of the saturation magnetization Ms in an environment of a temperature of 60° C. and a humidity of 90 RH % to 1.00 [%/8 weeks] or less.

The numerical definition of the reduction rate of the saturation magnetization Ms is particularly effective in the magnetic layer 43 in which the ratio R_{V/S} is 1.8 or less. The reason for this is as follows. As described above, when moisture is diffused into the magnetic layer 43 by long-term storage or the like, an acidic aqueous solution may be generated. When the ratio R_{V/S} is 1.8 or less, since the average particle surface area Sₐᵥₑ of the ferrite particles is larger than the average particle volume Vₐᵥₑ of the ferrite particles, the ferrite particles are easily affected by the acidic aqueous solution. Therefore, deterioration of the ferrite particles is particularly likely to be promoted, and there is a possibility that magnetic characteristics (for example, saturation magnetization Ms) are deteriorated.

In consideration of the above mechanism of deterioration of magnetic characteristics, in the magnetic layer 43 in which the ratio R_{V/S} is 1.8 or less, it is particularly effective to set the reduction rate of the saturation magnetization Ms to 1.00 [%/8 weeks] or less in an environment of a temperature of 60° C. and a humidity of 90 RH %.

### (Measurement Method of Reduction Rate of Saturation Magnetization Ms)

The reduction rate of the saturation magnetization Ms is obtained as follows.

### (Preparation of Extraction Sample)

The magnetic tape MT accommodated in the cartridge 10 is unwound, and four magnetic tapes MT having a length of 20 cm are cut out from a position of 30 m to 40 m in the longitudinal direction from one end on the outer peripheral side of the magnetic tape MT to obtain four extraction samples. A width of the extraction sample is similar to the width of the magnetic tape MT wound around the cartridge 10.

### (Preparation of Measurement Sample)

Two measurement samples are prepared from two extraction samples as follows. After one extraction sample is cut into five sheets, these five extraction samples are superimposed on each other so that the directions of the magnetic tape MT in the longitudinal direction are the same, and then punched out with a 06.39 mm punch to produce one measurement sample. At this time, marking is performed with an arbitrary ink having no magnetism so that the longitudinal direction (traveling direction) of the magnetic tape MT can be recognized. Similarly, one measurement sample is prepared from another extraction sample.

### (Preparation of Sample for Background Correction)

Two correction samples are prepared from the remaining two extraction samples as follows. The coating film (underlayer 42, magnetic layer 43, back layer 44, and the like) of one extraction sample is wiped off using acetone, ethanol, or the like, leaving only the base 41. Then, the obtained base 41 is cut into five sheets, and the five bases 41 are stacked by use of a double-sided adhesive tape, and then punched out with a punch of 6.39 mm to prepare a background correction sample (hereinafter simply referred to as a “correction sample”). At this time, marking is performed with an arbitrary ink having no magnetism so that the longitudinal direction (traveling direction) of the magnetic tape MT can be recognized. Similarly, one correction sample is prepared from another extraction sample.

### (Measurement of Saturation Magnetization Ms1 Before Environmental Storage)

Using one measurement sample and one correction sample, the saturation magnetization Ms1 before environmental storage is measured as follows. An M-H loop of the measurement sample (the entire magnetic tape MT) corresponding to the longitudinal direction (traveling direction) of the magnetic tape MT is measured using a vibrating sample magnetometer (VSM). The M-H loop of the correction sample (base 41) corresponding to the longitudinal direction of the base 41 (longitudinal direction of the magnetic tape MT) is measured using the VSM.

In the measurement of the M-H loop of the measurement sample (the entire magnetic tape MT) and the M-H loop of the correction sample (the base 41), a high-sensitivity vibrating sample magnetometer “VSM-P7-15 model” manufactured by Toei Industry Co., Ltd. is used. The measurement conditions are measurement mode: full loop, maximum magnetic field: 15 kOe, magnetic field step: 40 bit, time constant of locking amp: 0.3 sec, waiting time: 1 sec, and MH average number: 20.

By subtracting the M-H loop of the correction sample from the M-H loop of the measurement sample, background correction is performed, and an M-H loop after background correction is obtained. For calculation of the background correction, a measurement/analysis program attached to “model VSM-P7-15” is used. The saturation magnetization Ms1 before environmental storage is obtained from the obtained M-H loop after the background correction. For the calculation of this saturation magnetization Ms1, the measurement and analysis program attached to “VSM-P7-15 model” is used. It is assumed that every measurement of the M-H loop described above is performed at 25° C.±2° C. and 50% RH±5% RH. Furthermore, it is assumed that “demagnetizing field correction” when measuring the M-H loop in the longitudinal direction of the magnetic tape MT is not performed.

(Measurement of Saturation Magnetization Ms2 after Environmental Storage)

Using the remaining one measurement sample and the remaining one correction sample, the saturation magnetization Ms2 after environmental storage is measured as follows. The measurement sample and the correction sample are placed on a petri dish and stored in an environment of a temperature of 60° C. and a humidity of 90% RH for 8 weeks. After storage for 8 weeks, the saturation magnetization Ms2 after environmental storage is obtained in a similar manner to the above “Measurement of saturation magnetization Ms1 before environmental storage”.

### (Calculation of Reduction Rate of Saturation Magnetization Ms)

The reduction rate [%] of the saturation magnetization Ms in an environment of a temperature of 60° C. and a humidity of 90 RH % is calculated by the following formula.

$$Reduction rate of saturation magnetization Ms [ \% ] = 100 - [ ( Ms 2 / Ms 1 ) \times 100 ]$$

(Attenuation Amount of Reproduction Signal after Lapse of 10 Years)

An attenuation amount of the reproduction signal after a lapse of 10 years, the reproduction signal being measured after storage for 8 weeks in an environment at a temperature of 60° C. and a humidity of 90 RH %, is preferably 1.5 dB or less, more preferably 1.0 dB or less, 0.9 dB or less, 0.8 dB or less, 0.7 dB or less, 0.6 dB or less, 0.5 dB or less, 0.4 dB or less, or 0.3 dB or less. When the attenuation amount of the reproduction signal is 1.5 dB or less, long-term storage stability for at least 10 years can be obtained.

First, the magnetic tape MT accommodated in the cartridge 10 is unwound, and the magnetic tape MT is cut out by a length of 1 m from a position of 30 m to 40 m in the longitudinal direction from one end on the outer peripheral side of the magnetic tape MT to obtain a sample. Next, the attenuation amount of the reproduction signal after a lapse of 10 years is measured on the basis of the descriptions of the following documents (1) and (2).

### (1) “Long-Term Storage Performance of Barium Ferrite Medium for Linear Tape System”

Technical Research Report of the Institute of Electronics, Information and Communication Engineers. MR, Magnetic Recording 112(137), 53-57, 2012 Jul. 12

### (2) “Influence of Thermal Stability Parameter Distribution on Barium Ferrite Magnetic Tape”

Technical Research Report of the Institute of Electronics, Information and Communication Engineers. 113(127), 25-29, 2013 Jul. 12

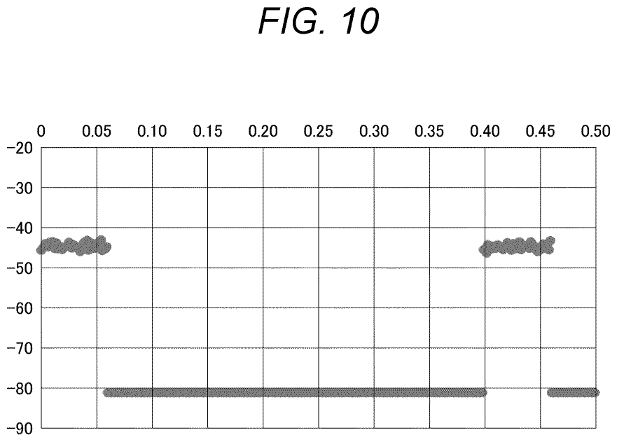

Specifically, the attenuation amount of the reproduction signal after the lapse of 10 years is measured as follows. First, the sample is placed on a petri dish and stored in an environment of a temperature of 60° C. and a humidity of 90% RH for 8 weeks. Next, the loop-shaped magnetic tape is set in a loop tester manufactured by Microphysics Co., Ltd. to which a recording and reproducing system of LTO8 is attached, a signal of 92 nm/bit is recorded once, and then reproduction is repeated for 100 sec. The loop-shaped magnetic tape is manufactured by forming a magnetic tape having a length of 1 m into a loop shape and joining the back side of the magnetic tape with a splice tape (silver, 3M (TC) 0.5-5-4380). The recording signal is generated using an AWG2021Arbitrary waveform generator manufactured by Tektronix. As a recording/reproducing amplifier head, a head of an LTO standard drive is used. The reproduction signal is read by a 8591E spectrum analyzer manufactured by Hewlett-Packard (HP). FIG. 10 illustrates an example of the reproduction signal read by the 8591E spectrum analyzer.

The acquisition conditions of the reproduction signal are as follows.

Traveling speed: 2 m/sec 10 MHz signal writing, 2T equivalent to 100 nm/bit

SWP: 500 msec

Sampling point: 400

Resolution: 0.00125 sec/point

RBW: 1 MHz

VBW: 1 MHz

Gate length: 60 msec

Gate delay: min

Large delay: 0 msec

SWP: 500 msec

Pene: +0.5

Iw: 5.66 (shot possible lower limit)

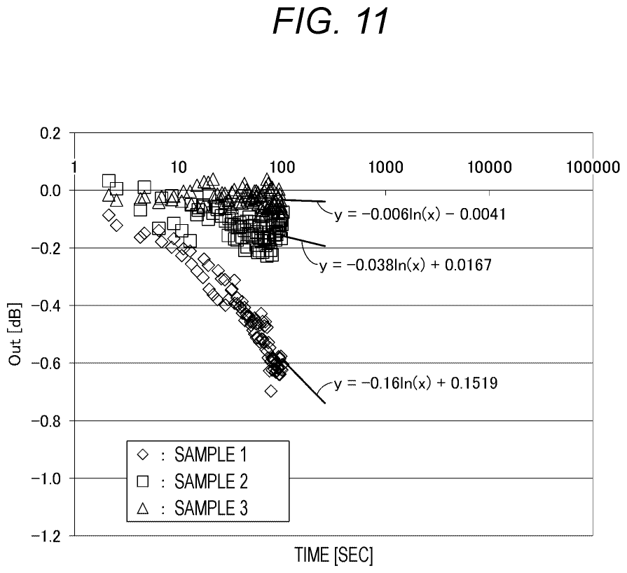

After the output signals for 400 sampling points are read by the spectrum analyzer, the output signals for 3 points at each of both ends of a certain output portion are removed from the read output signal. An average value of the output signals after the removal is calculated and used as a reproduction signal output. This measurement is made every second for 100 seconds. The measurement for 100 seconds is repeated 4 times, an average at each time in the 4 times of measurement is calculated, and a graph in which the horizontal axis is time [sec] and the vertical axis is the reproduction signal output [dB] is created. At this time, the horizontal axis (time [sec]) is set to the logarithmic axis, and the vertical axis (reproduction signal output [dB]) is set to the linear axis. The graph is a graph representing an attenuation amount of the reproduction signal. An example of the graph is illustrated in FIG. 11.

An approximate straight line is obtained from the created graph by logarithmic approximation. For the calculation of the approximate straight line, the “addition of approximate curve” function of Excel (registered trademark) of Microsoft (registered trademark) is used. The version of above-described Excel (registered trademark) of Microsoft (registered trademark) is Microsoft (registered trademark) Excel (registered trademark) for Microsoft 365 MSO. The obtained approximate straight line is extrapolated, and the attenuation amount of the reproduction signal at the time corresponding to 10 years after the environmental storage is read.

### (Coercive Force Hc2)

An upper limit value of the coercive force Hc2 of the magnetic layer 43 in the longitudinal direction of the magnetic tape MT is preferably 2000 Oe or less, more preferably 1900 Oe or less, and still more preferably 1800 Oe or less. When the coercive force Hc2 of the magnetic layer 43 in the longitudinal direction of the magnetic tape MT is 2000 Oe or less, sufficient electromagnetic conversion characteristics can be achieved even at a high recording density.

A lower limit value of the coercive force Hc2 of the magnetic layer 43 measured in the longitudinal direction of the magnetic tape MT is preferably 1000 Oe or more. When the coercive force Hc2 of the magnetic layer 43 measured in the longitudinal direction of the magnetic tape MT is 1000 Oe or more, it is possible to suppress demagnetization due to a leakage flux from the recording head.

The coercive force Hc2 described above is obtained as follows. First, one measurement sample and one correction sample are prepared in a similar manner to the method of measuring the reduction rate of the saturation magnetization Ms, and then the M-H loop of the measurement sample and the M-H loop of the correction sample are measured in a similar manner to the method of measuring the reduction rate of the saturation magnetization Ms. The measurement device, the measurement conditions, and the measurement environment of the M-H loop are as described in the method for measuring the reduction rate of the saturation magnetization Ms.

Next, an M-H loop after background correction is obtained in a similar manner to the method of measuring the reduction rate of the saturation magnetization Ms described above. The coercive force Hc2 is obtained from the obtained M-H loop after the background correction. Note that for the calculation of this coercive force Hc2, the measurement and analysis program attached to “VSM-P7-15 model” is used.

### (Square Ratio)

A square ratio S1 of the magnetic layer 43 in the vertical direction of the magnetic tape MT is preferably 62% or more, more preferably 65% or more, still more preferably 68% or more, particularly preferably 72% or more, and most preferably 75% or more. When the square ratio S1 is 62% or more, the vertical orientation of the ferrite particles is sufficiently high, so that more excellent electromagnetic conversion characteristics can be obtained.

The square ratio S1 of the magnetic tape MT in the vertical direction is obtained as follows. First, one measurement sample and one correction sample are prepared in a similar manner to the method of measuring the reduction rate of the saturation magnetization Ms, and then the M-H loop of the measurement sample and the M-H loop of the correction sample are measured in a similar manner to the method of measuring the reduction rate of the saturation magnetization Ms. The measurement device, the measurement conditions, and the measurement environment of the M-H loop are as described in the method for measuring the reduction rate of the saturation magnetization Ms.

Next, an M-H loop after background correction is obtained in a similar manner to the method of measuring the reduction rate of the saturation magnetization Ms described above. The square ratio S1 [%] is calculated by substituting saturation magnetization Ms (emu) and residual magnetization Mr (emu) of the obtained M-H loop after the background correction into the following formula. Note that for the calculation of this square ratio S1, the measurement and analysis program attached to “VSM-P7-15 model” is used.

$$Square ratio S 1 [ \% ] = ( Mr / Ms ) \times 100$$

A square ratio S2 of the magnetic layer 43 in the longitudinal direction (traveling direction) of the magnetic tape MT is preferably 35% or less, more preferably 30% or less, still more preferably 25% or less, particularly preferably 20% or less, and most preferably 15% or less. When the square ratio S2 is 35% or less, the vertical orientation of the ferrite particles is sufficiently high, so that more excellent electromagnetic conversion characteristics can be obtained. Note that one of the square ratio S1 of the magnetic layer 43 in the vertical direction of the magnetic tape MT and the square ratio S2 of the magnetic layer 43 in the longitudinal direction (traveling direction) of the magnetic tape MT may be within the above preferable range, and the other may be out of the above preferable range. Alternatively, both the square ratio S1 of the magnetic layer 43 in the vertical direction of the magnetic tape MT and the square ratio S2 of the magnetic layer 43 in the longitudinal direction (traveling direction) of the magnetic tape MT may be within the above preferable ranges.

The square ratio S2 of the magnetic tape MT in the longitudinal direction is obtained in a manner similar to that of the square ratio S1 except that the M-H loop is measured in the longitudinal direction (traveling direction) of the magnetic tape MT and the base 41.

### (Ratio Hc2/Hc1)

A ratio Hc2/Hc1 of the coercive force Hc1 of the magnetic layer 43 in the vertical direction of the magnetic tape MT to the coercive force Hc2 of the magnetic layer 43 in the longitudinal direction of the magnetic tape MT preferably satisfies a relationship of Hc2/Hc1≤0.8, more preferably Hc2/Hc1≤0.75, still more preferably Hc2/Hc1≤0.7, particularly preferably Hc2/Hc1≤0.65, and most preferably Hc2/Hc1≤0.6. When the coercive forces Hc1 and Hc2 satisfy the relationship of Hc2/Hc1≤0.8, a degree of vertical orientation of the ferrite particles can be increased. Therefore, it is possible to reduce a magnetization transition width and to obtain a high-output signal at the time of signal reproduction, so that more excellent electromagnetic conversion characteristics can be obtained. Note that when Hc2 is small as described above, the magnetization reacts with a high degree of sensitivity by a vertical magnetic field from the recording head, so that a good recording pattern may be formed.

In a case where the ratio Hc2/Hc1 is Hc2/Hc1≤0.8, it is particularly effective that the average thickness t₁ of the magnetic layer 43 is 90 nm or less. When the average thickness t₁ of the magnetic layer 43 exceeds 90 nm, in a case where a ring-type head is used as the recording head, a lower region (a region on the underlayer 42 side) of the magnetic layer 43 would be magnetized in the longitudinal direction of the magnetic tape MT, and it may become impossible to uniformly magnetize the magnetic layer 43 in the thickness direction. Therefore, it may be impossible to obtain more excellent electromagnetic conversion characteristics even when the ratio Hc2/Hc1 is set to be Hc2/Hc1≤0.8 (namely, even when the degree of vertical orientation of the ferrite particles is enhanced).

A lower limit value of Hc2/Hc1 is not particularly limited, and is, for example, 0.5≤Hc2/Hc1. Note that Hc2/Hc1 represents the degree of vertical orientation of the ferrite particles, and the smaller Hc2/Hc1, the higher the degree of vertical orientation of the ferrite particles.

The method of measuring the coercive force Hc2 of the magnetic layer 43 in the longitudinal direction of the magnetic tape MT is as described above. The coercive force Hc1 of the magnetic layer 43 in the vertical direction of the magnetic tape MT is obtained similarly to the coercive force Hc2 of the magnetic layer 43 in the longitudinal direction of the magnetic tape MT except that the M-H loop is measured in the vertical direction (thickness direction) of the magnetic tape MT and the base 41.

### (Activation Volume V_{act})

An activation volume V_{act} is preferably 8000 nm³ or less, more preferably 6000 nm³ or less, still more preferably 5000 nm³ or less, particularly preferably 4000 nm³ or less, and most preferably 3000 nm³ or less. When the activation volume V_{act} is 8000 nm³ or less, a dispersion state of the ferrite particles becomes excellent, so that a bit inversion region may be made steep, and it is possible to suppress the deterioration in magnetic signal recorded in an adjacent track by a leakage magnetic field from the recording head. Therefore, there is a possibility that more excellent electromagnetic conversion characteristics cannot be obtained.

The activation volume V_{act} described above is obtained by following formula derived by Street and Woolley.

$${V}_{act} ( {nm}^{3} ) = {k}_{B} \times T \times {X}_{irr} / ( {μ}_{0} \times Ms \times S )$$

(where k_{B}: Boltzmann's constant (1.38×10⁻²³ J/K), T: temperature (K), Xᵢᵣᵣ: irreversible magnetic susceptibility, μ₀: vacuum magnetic permeability, S: magnetic viscosity coefficient, and Ms: saturation magnetization (emu/cm³))

The irreversible magnetic susceptibility Xᵢᵣᵣ, the saturation magnetization Ms, and the magnetic viscosity coefficient S to be substituted in the above formula are obtained as follows by using the VSM. Note that a measurement direction by the VSM is assumed to be the vertical direction (thickness direction) of the magnetic tape MT. Furthermore, it is assumed that the measurement by the VSM is performed on the measurement sample cut out from the elongated magnetic tape MT at 25° C.±2° C. and 50% RH±5% RH. Furthermore, it is assumed that “demagnetizing field correction” when measuring the M-H loop in the vertical direction (thickness direction) of the magnetic tape MT is not performed.

### (Irreversible Magnetic Susceptibility Xᵢᵣᵣ)

The irreversible magnetic susceptibility Xᵢᵣᵣ is defined as an inclination in the vicinity of a residual coercive force Hr in an inclination of a residual magnetization curve (DCD curve). First, a magnetic field of −1193 kA/m (15 KOe) is applied to a whole of the magnetic tape MT, and the magnetic field is returned to zero to obtain a residual magnetization state. Thereafter, a magnetic field of about 15.9 kA/m (200 Oe) is applied in the opposite direction to return to zero again, and a residual magnetization amount is measured. Thereafter, similarly, measurement to apply a magnetic field larger than the above-described applied magnetic field by 15.9 kA/m to return to zero is repeatedly performed, the residual magnetization amount is plotted to the applied magnetic field, and the DCD curve is measured. From the obtained DCD curve, a point at which the magnetization amount is zero is made the residual coercive force Hr, the DCD curve is further differentiated, and the inclination of the DCD curve at each magnetic field is obtained. In the inclination of this DCD curve, the inclination in the vicinity of the residual coercive force Hr is Xᵢᵣᵣ.

### (Saturation Magnetization Ms)

First, an M-H loop after background correction is obtained in a manner similar to the method of measuring the square ratio S1 described above. Next, Ms (emu/cm³) is calculated from a value of saturation magnetization Ms (emu) of the obtained M-H loop and a volume (cm³) of the magnetic layer 43 in the measurement sample. Note that the volume of the magnetic layer 43 is obtained by multiplying an area of the measurement sample by the average thickness t₁ of the magnetic layer 43. The method of measuring the average thickness t₁ of the magnetic layer 43 required for calculating the volume of the magnetic layer 43 is as described above.

### (Magnetic Viscosity Coefficient S)

First, a magnetic field of −1193 kA/m (15 kOe) is applied to a whole of the magnetic tape MT (measurement sample), and the magnetic field is returned to zero to obtain the residual magnetization state. Thereafter, a magnetic field equivalent to the value of the residual coercive force Hr obtained from the DCD curve is applied in the opposite direction. The magnetization amount is continuously measured at regular time intervals for 1000 seconds in a state in which the magnetic field is applied. A magnetic viscosity coefficient S is calculated by checking a relationship between time t and the magnetization amount M(t) against the following formula obtained in this manner.

$$M ( t ) = M 0 + S \times ln ( t )$$

(where M(t): magnetization amount at time t, M0: initial magnetization amount, S: magnetic viscosity coefficient, and ln(t): natural logarithm of time)

### (Surface Roughness R_{b} of Back Surface)

A surface roughness R_{b} of the back surface (surface roughness of the back layer 44) preferably satisfies Rb≤6.0 [mm]. When the surface roughness R_{b} of the back surface is in the above range, more excellent electromagnetic conversion characteristics can be obtained.

The surface roughness R_{b} of the back surface is obtained as follows. First, the magnetic tape MT accommodated in the cartridge 10 is unwound, and the magnetic tape MT is cut out to a length of 100 mm at a position of 30 m to 40 m in the longitudinal direction from one end on the outer peripheral side of the magnetic tape MT, thereby preparing a sample. Next, the sample is placed on a slide glass so that a surface to be measured (surface on the magnetic layer 43 side) of the sample is oriented upwardly, and an end portion of the sample is fixed with a mending tape. The surface shape is measured using VertScan (20× objective lens) as a measurement device, and the surface roughness R_{b} of the back surface is obtained from the following formula on the basis of the standard of ISO 25178.

The measurement conditions are as follows.

Device: Non-contact roughness meter using optical interference

(non-contact surface/layer cross-section shape measurement system VertScan R5500GL-M100-AC manufactured by Ryoka Systems Inc.)

Objective lens: 20 times

Measurement region: 640×480 pixels (field of view: about 237 μm×178 μm field of view)

Measurement mode: Phase

Wavelength filter: 520 nm

CCD: ⅓ inch

Noise removal filter: Smoothing 3×3

Surface correction: Correction on quadratic polynomial approximated surface

Measurement software: VS-Measure Version 5.5.2

Analysis software: VS-viewer Version 5.5.5

$${S}_{a} = \frac{1}{A} \int {\int }_{A} \vert Z ( x , y ) \vert dxdy \qquad [ Mathematical formula 3 ]$$

After measuring the surface roughness at five points in the longitudinal direction of the magnetic tape MT as described above, an average value of arithmetic average roughnesses Sₐ (nm) automatically calculated from the surface profile obtained at each position is taken as the surface roughness R_{b} (nm) of the back surface.

### (Young's Modulus of Magnetic Tape in Longitudinal Direction)

An upper limit value of the Young's modulus of the magnetic tape MT in the longitudinal direction is preferably 9.0 GPa or less, more preferably 8.0 GPa or less, still more preferably 7.5 GPa or less, and particularly preferably 7.1 GPa or less. When the Young's modulus of the magnetic tape MT in the longitudinal direction is 9.0 GPa or less, the stretchability of the magnetic tape MT due to the external force further increases, so that adjustment of the width of the magnetic tape MT by tension adjustment is further facilitated. Therefore, off-track can be more suitably suppressed, and data recorded on the magnetic tape MT can be more accurately reproduced. A lower limit value of the Young's modulus of the magnetic tape MT in the longitudinal direction is preferably 3.0 GPa or more, and more preferably 4.0 GPa or more. When the lower limit value of the Young's modulus of the magnetic tape MT in the longitudinal direction is 3.0 GPa or more, a decrease in traveling stability can be suppressed.

The Young's modulus of the magnetic tape MT in the longitudinal direction is a value indicating the difficulty of expansion and contraction of the magnetic tape MT in the longitudinal direction due to an external force. The larger this value, the more difficult the magnetic tape MT is expanded and contracted in the longitudinal direction due to the external force. The smaller this value, the easier the magnetic tape MT is expanded and contracted in the longitudinal direction due to the external force.

Note that the Young's modulus of the magnetic tape MT in the longitudinal direction is a value relating to the magnetic tape MT in the longitudinal direction, and is correlated with the difficulty of expansion and contraction of the magnetic tape MT in the width direction. That is, the larger this value, the more difficult the magnetic tape MT is expanded and contracted in the width direction due to an external force. The smaller this value, the easier the magnetic tape MT is expanded and contracted in the width direction due to the external force. Therefore, from the viewpoint of tension adjustment, it is advantageous that the Young's modulus of the magnetic tape MT in the longitudinal direction is small as described above and is 9.0 GPa or less.

For measurement of the Young's modulus, a tensile tester (manufactured by Shimadzu Corporation, AG-100D) is used. In a case where the Young's modulus in the tape longitudinal direction is desired to be measured, the magnetic tape MT accommodated in the cartridge 10 is unwound, and the magnetic tape MT is cut out to a length of 180 mm at a position of 30 m to 40 m in the longitudinal direction from one end on the outer peripheral side of the magnetic tape MT, thereby preparing a sample. A jig capable of fixing the tape width (½ inch) is attached to the tensile tester described above to fix the top and bottom of the tape width. The distance (length of the tape between chucks) is set to 100 mm. After chucking the data sample, stress is gradually applied in the direction of pulling the sample. The tensile speed is 0.1 mm/min. The Young's modulus is calculated using the following formula on the basis of the change in stress and the amount of elongation at this time.

$$E ( N / {m}^{2} ) = ( ( Δ N / S ) / ( Δ x / L ) ) \times {10}^{6}$$

ΔN: Change in stress (N)
S: Cross-sectional area of test piece (mm²)
Δx: Elongation amount (mm)
L: Distance between gripping jigs (mm)

A cross-sectional area S of the measurement sample 10S described above is a cross-sectional area before tensile operation, and is obtained by a product of the width (½ inch) of the measurement sample 10S and the thickness of the measurement sample 10S. For a range of tensile stress at the time of measurement, the range of the tensile stress in a linear region is set according to the thickness of the magnetic tape MT or the like. In this case, the range of the stress is 0.2 N to 0.7 N, and the change in stress (ΔN) and the elongation amount (Δx) at this time are used for calculation. Note that the measurement of the Young's modulus described above is performed at 25° C.±2° C. and 50% RH±5% RH.

### (Young's Modulus of Base in Longitudinal Direction)

The Young's modulus of the base 41 in the longitudinal direction is preferably 7.8 GPa or less, more preferably 7.0 GPa or less, still more preferably 6.6 GPa or less, and particularly preferably 6.4 GPa or less. When the Young's modulus of the base 41 in the longitudinal direction is 7.8 GPa or less, the stretchability of the magnetic tape MT due to the external force further increases, so that adjustment of the width of the magnetic tape MT by tension adjustment is further facilitated. Therefore, off-track can be more suitably suppressed, and data recorded on the magnetic tape MT can be more accurately reproduced. The lower limit value of the Young's modulus of the base 41 in the longitudinal direction is preferably 2.5 GPa or more, and more preferably 3.0 GPa or more. When the lower limit value of the Young's modulus of the base 41 in the longitudinal direction is 2.5 GPa or more, the decrease in traveling stability can be suppressed.

The Young's modulus of the base 41 described above in the longitudinal direction is determined as follows. First, the magnetic tape MT accommodated in the cartridge 10 is unwound, and the magnetic tape MT is cut out to a length of 180 mm at a position of 30 m to 40 m in the longitudinal direction from one end on the outer peripheral side of the magnetic tape MT. Subsequently, the underlayer 42, the magnetic layer 43, and the back layer 44 are removed from the cut magnetic tape MT to obtain the base 41. Using this base 41, the Young's modulus of the base 41 in the longitudinal direction is obtained in a similar procedure to the above-mentioned Young's modulus of the magnetic tape MT described above in the longitudinal direction.

The thickness of the base 41 is half or more of the thickness of the entire magnetic tape MT. Therefore, the Young's modulus of the base 41 in the longitudinal direction is correlated with the difficulty of expansion and contraction of the magnetic tape MT due to an external force. The larger this value, the more difficult the magnetic tape MT is expanded and contracted in the width direction due to the external force. The smaller this value, the easier the magnetic tape MT is expanded and contracted in the width direction due to the external force.

Note that the Young's modulus of the base 41 in the longitudinal direction is a value relating to the magnetic tape MT in the longitudinal direction, and is correlated with the difficulty of expansion and contraction of the magnetic tape MT in the width direction. That is, the larger this value, the more difficult the magnetic tape MT is expanded and contracted in the width direction due to an external force. The smaller this value, the easier the magnetic tape MT is expanded and contracted in the width direction due to the external force. Therefore, from the viewpoint of tension adjustment, it is advantageous that the Young's modulus of the base 41 in the longitudinal direction is small as described above and is 7.8 GPa or less.

### [5 Manufacturing Method of Magnetic Tape]

Next, an example of a manufacturing method of the magnetic tape MT having the configuration described above will be described.

### (Preparation Step of Coating Material)

First, nonmagnetic particles, a binder, and the like are kneaded and dispersed in a solvent to prepare an underlayer forming coating material. Next, ferrite particles, a binder, an acidic compound as an additive, and the like are kneaded and dispersed in a solvent to prepare a magnetic layer forming coating material. For the preparation of the magnetic layer forming coating material and the underlayer forming coating material, for example, the following solvents, dispersing device, and kneading device can be used.

Examples of the solvent used for the coating material preparation described above include, for example, ketone solvents such as acetone, methyl ethyl ketone, methyl isobutyl ketone, and cyclohexanone, alcohol solvents such as methanol, ethanol, and propanol, ester solvents such as methyl acetate, ethyl acetate, butyl acetate, propyl acetate, ethyl lactate, and ethylene glycol acetate, ether solvents such as diethylene glycol dimethyl ether, 2-ethoxyethanol, tetrahydrofuran, and dioxane, aromatic hydrocarbon solvents such as benzene, toluene, and xylene, halogenated hydrocarbon solvents such as methylene chloride, ethylene chloride, carbon tetrachloride, chloroform, and chlorobenzene. They may be used alone, or they may be mixed appropriately.

As a kneading device used for the coating material preparation described above, for example, kneading devices such as a continuous two-axis kneader, a continuous two-axis kneader capable of diluting in multiple stages, a kneader, a pressure kneader, and a roll kneader may be used, but this is not especially limited to such devices. Furthermore, as a dispersing device used for the coating material preparation described above, for example, dispersing devices such as a roll mill, a ball mill, a horizontal sand mill, a vertical sand mill, a spike mill, a pin mill, a tower mill, a pearl mill (for example, “DCP mill” manufactured by Eirich Co., Ltd. and the like), a homogenizer, and an acoustic wave dispersing device may be used, but it is not especially limited to these devices.

### (Application Step)

Next, the underlayer forming coating material is applied to one principal surface of the base 41 and dried to form the underlayer 42. Subsequently, the magnetic layer forming coating material is applied onto the underlayer 42 and dried to form the magnetic layer 43 on the underlayer 42. Note that, at the time of drying, ferrite particles may be magnetically oriented in the thickness direction of the base 41 by, for example, a solenoid coil. Furthermore, at the time of drying, ferrite particles may be magnetically oriented in the thickness direction of the base 41 after the ferrite particles are magnetically oriented in the traveling direction (longitudinal direction) of the base 41 by, for example, the solenoid coil. By performing the process of temporarily orienting the ferrite particles in the longitudinal direction as described above, the degree of vertical orientation (that is, the square ratio S1) of the ferrite particles can be further improved. After the magnetic layer 43 is formed, the back layer 44 is formed on the other principal surface of the base 41. Therefore, the magnetic tape MT is obtained. Note that the order of formation of the underlayer 42, the magnetic layer 43, and the back layer 44 is not limited to the above example. For example, after the back layer 44 is formed on the other principal surface of the base 41, the underlayer 42 and the magnetic layer 43 may be sequentially formed on one principal surface of the base 41.

The square ratios S1 and S2 are, for example, set to desired values by adjusting strength of the magnetic field applied to the coating film of the magnetic layer forming coating material, concentration of a solid content in the magnetic layer forming coating material, and a drying condition of the coating film of the magnetic layer forming coating material (drying temperature and drying time). The strength of the magnetic field applied to the coating film is preferably twice or more and three times or less of the coercive force of the ferrite particles. In order to further increase the square ratio S1 (that is, to further decrease the square ratio S2), it is preferable to improve the dispersion state of the ferrite particles in the magnetic layer forming coating material. Furthermore, in order to further increase the square ratio S1, it is also effective to magnetize the ferrite particles at a stage before the magnetic layer forming coating material enters an orienting device for performing the magnetic field orientation of the ferrite particles. Note that, the methods of adjusting the square ratios S1 and S2 may be used alone, or two or more methods may be used in combination.

### (Curing Step)

Next, after the magnetic tape MT is wound into a roll shape, heat treatment is performed in this state to the magnetic tape MT to cure the underlayer 42 and the magnetic layer 43.

### (Calendering Step)

Next, the obtained magnetic tape MT is subjected to calendering treatment to smooth the magnetic surface.

### (Demagnetization Step and Servo Pattern Writing Step)

Next, after demagnetization of the magnetic tape MT is performed as necessary, the servo pattern may be written on the magnetic tape MT.

### (Cutting Step)

Next, the magnetic tape MT is cut into a predetermined width (for example, ½ inch width). Thus, the magnetic tape MT is obtained.

### (Adjustment Method of Reduction Rate of Saturation Magnetization Ms)

The reduction rate of the saturation magnetization Ms in an environment of a temperature of 60° C. and a humidity of 90 RH % can be adjusted to a desired value, for example, by adjusting the type and blending amount of the acidic compound in the preparation step of the coating material and the heat treatment conditions (for example, the heat treatment temperature and the heat treatment time) in the curing step.

In a case where the acidic compound includes at least one acidic functional group, the blending amount of the acidic compound with respect to 100 parts by mass of the blending amount of the ferrite particles is preferably 1.0% by mass or more and 4.5% by mass or less. When the blending amount of the acidic compound is 1.0% by mass or more, a decrease in the amount of the acidic compound adsorbed to the surfaces of the ferrite particles can be suppressed. When the blending amount of the acidic compound is 4.5% by mass or less, the amount of the acidic compound present in the magnetic layer 43 without being adsorbed to the surfaces of the ferrite particles can be reduced.

The heat treatment temperature in the curing step is preferably 55° C. or more and 75° C. or less. When the heat treatment temperature is 55° C. or more, the amount of the acidic compound present in the magnetic layer 43 without being adsorbed to the surfaces of the ferrite particles can be reduced. When the heat treatment temperature is 75° C. or less, deterioration of surface roughness due to the flow of the binder can be suppressed.

The heat treatment time in the curing step is preferably 15 hours or more and 100 hours or less. When the heat treatment time is 15 hours or more, the amount of the acidic compound present in the magnetic layer 43 without being adsorbed on the surfaces of the ferrite particles can be reduced. When the heat treatment time is 100 hours or less, deterioration in productivity of the magnetic tape MT can be suppressed.

### [6 Operations and Effects]

As described above, in the magnetic tape MT according to an embodiment, the reduction rate of the saturation magnetization Ms in an environment of a temperature of 60° C. and a humidity of 90 RH % is 1.00 [%/8 weeks] or less. Therefore, even in a case where the average particle volume of the ferrite particles is 1400 nm³ or less, deterioration of electromagnetic conversion characteristics due to storage can be suppressed. The storage may be long-term storage. The long-term storage may be for a period of at least 10 years.

Since an environmental temperature range in use and storage of a conventional magnetic tape is narrower than an environmental temperature range in use and storage of a hard disk drive (HDD), a semiconductor memory, or the like, it is desired to expand the environmental temperature range in use and storage of the magnetic tape. When the magnetic tape can be used and stored in an environmental temperature range similar to or close to the HDD, the semiconductor memory, or the like, it is considered that the use range of the magnetic tape is greatly expanded.

In the magnetic tape MT according to an embodiment, as described above, since the reduction rate of the saturation magnetization Ms in an environment at a temperature of 60° C. and a humidity of 90 RH % is 1.00 [%/8 weeks] or less, the environmental temperature range in use (actual traveling) and storage of the magnetic tape MT can be expanded.

### [7. Modifications]

In one embodiment described above, a case where the magnetic tape cartridge is the one-reel type cartridge 10 has been described; however, the magnetic tape cartridge may be a two-reel type cartridge.

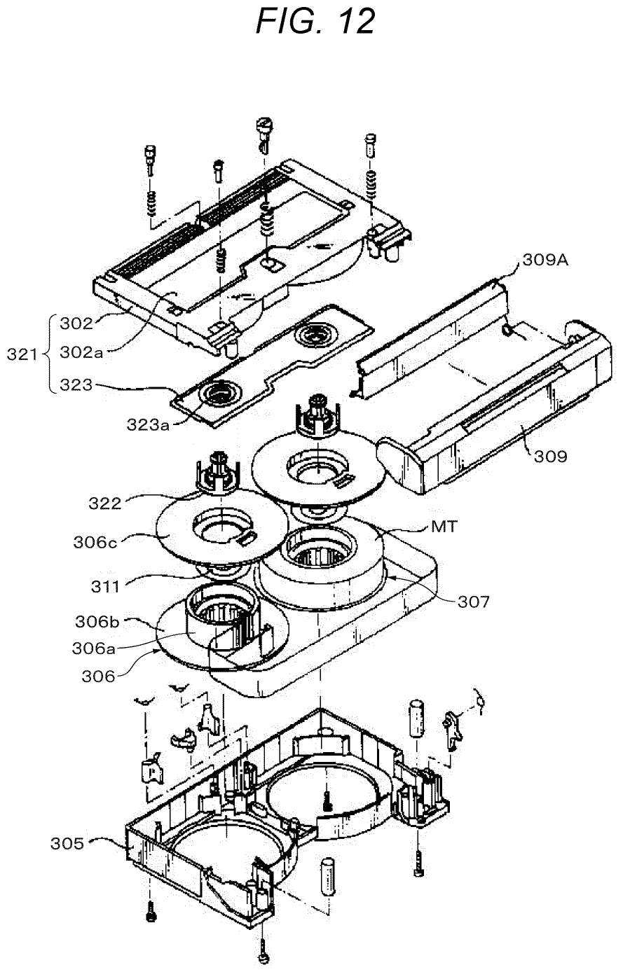

FIG. 12 is an exploded perspective view illustrating an example of a configuration of a two-reel type cartridge 321. The cartridge 321 includes an upper half 302 including a synthetic resin, a transparent window member 323 fitted and fixed to a window portion 302a opened in an upper surface of the upper half 302, a reel holder 322 fixed to an inner side of the upper half 302 and preventing uplift of reels 306 and 307, a lower half 305 corresponding to the upper half 302, the reels 306 and 307 accommodated in a space formed by combining the upper half 302 and the lower half 305, a magnetic tape MT wound around the reels 306 and 307, a front lid 309 closing a front side opening formed by combining the upper half 302 and the lower half 305, and a back lid 309A protecting the magnetic tape MT exposed at the front side opening.

The reels 306 and 307 are for winding the magnetic tape MT. The reel 306 includes a lower flange 306b including, in a central portion, a cylindrical hub portion 306a around which the magnetic tape MT is wound, an upper flange 306c having substantially the same size as the lower flange 306b, and a reel plate 311 interposed between the hub portion 306a and the upper flange 306c. The reel 307 has a configuration similar to that of the reel 306.

The window member 323 is provided with attachment holes 323a at positions corresponding to the reels 306 and 307, respectively, for assembling the reel holder 322 as a reel holding unit that prevents the reels from being lifted up. The magnetic tape MT is similar to the magnetic tape MT in the first embodiment.

### EXAMPLES

Hereinafter, the present disclosure will be specifically described with reference to Examples, but the present disclosure is not limited to these Examples.

In the following Examples and Comparative Examples, an average particle surface area Sₐᵥₑ, an average particle volume Vₐᵥₑ, a ratio R_{V/S} (=Vₐᵥₑ/Sₐᵥₑ), an average plate diameter DBₐᵥₑ, an average plate thickness DAₐᵥₑ, an average thickness of the magnetic tape, an average thickness of the magnetic layer, an average thickness of the underlayer, an average thickness of the base film (base), an average thickness of the back layer, a square ratio S1 of the magnetic layer in the vertical direction of the magnetic tape, and a square ratio S2 of the magnetic layer in the longitudinal direction of the magnetic tape are values obtained by the measurement method described in one embodiment described above.

### Example 1

### (Preparation Step of Magnetic Layer Forming Coating Material)

A magnetic layer forming coating material was prepared as follows. First, a first composition having the following formulation was kneaded with an extruder. Next, the kneaded first composition and a second composition having the following formulation were added to a stirring tank provided with a disperser, and premixing was performed. Subsequently, dyno mill mixing was further performed, and filter treatment was performed to prepare a magnetic layer forming coating material.

### (First Composition)

Magnetic powder B (see Table 2): 100.0 parts by mass

Vinyl chloride-based resin solution (Formulation of resin solution: 30% by mass of vinyl chloride-based resin, 70% by mass of cyclohexanone solution): 30.0 parts by mass

(Degree of polymerization 300, number average molecular weight Mn=10000, containing OSO₃K=0.07 mmol/g, and secondary OH=0.3 mmol/g as a polar group)

Polyurethane resin solution (formulation of resin solution: blending amount of polyurethane resin 30.0% by mass, blending amount of cyclohexanone 70.0% by mass): 30.0 parts by mass

(Polyurethane resin: Number average molecular weight Mn=25000, glass transition temperature Tg=110° C.)

Aluminum oxide powder: 6.0 parts by mass (α-Al₂O₃, average particle diameter: 0.1 μm)

Phenylphosphonic acid: 3.0 parts by mass

### (Second Composition)

Carbon black: 2.5 parts by mass (manufactured by Tokai Carbon Co., Ltd., trade name: SEAST S, arithmetic average particle size 70 nm)

Polyurethane resin solution (formulation of resin solution: blending amount of polyurethane resin 30.0% by mass, blending amount of cyclohexanone 70.0% by mass): 6.5 parts by mass

(Polyurethane resin: Number average molecular weight Mn=25000, glass transition temperature Tg=110° C.)

n-butyl stearate: 2.0 parts by mass

Methyl ethyl ketone: 121.0 parts by mass

Toluene: 121.0 parts by mass

Cyclohexanone: 116.0 parts by mass

Finally, 3.0 parts by mass of polyisocyanate (trade name: Coronate L, manufactured by Tosoh Corporation) as a curing agent and 2.0 parts by mass of stearic acid were added to the magnetic layer forming coating material prepared as described above.

### (Preparation Step of Underlayer Forming Coating Material)

An underlayer forming coating material was prepared as follows. First, a third composition having the following formulation was kneaded with an extruder. Next, the kneaded third composition and a fourth composition having the following formulation were added to a stirring tank provided with a disperser, and premixing was performed. Subsequently, dyno mill mixing was further performed and filter treatment was performed to prepare the underlayer forming coating material.

### (Third Composition)

Needle-shaped iron oxide powder: 100.0 parts by mass

(α-Fe₂O₃, average long axis length 0.11 μm)

Vinyl chloride-based resin (formulation of resin solution: 30% by mass of vinyl chloride-based resin, 70% by mass of cyclohexanone solution): 50.0 parts by mass

(Degree of polymerization 300, number average molecular weight Mn=10000, containing OSO₃K=0.07 mmol/g, and secondary OH=0.3 mmol/g as a polar group)

Aluminum oxide powder: 3.0 parts by mass (α-Al₂O₃, average particle diameter: 0.1 μm)

### (Fourth Composition)

Carbon black (manufactured by Asahi Carbon Co., Ltd., trade name: #80): 25.0 parts by mass

Polyurethane resin solution (formulation of resin solution: blending amount of polyurethane resin 30.0% by mass, blending amount of cyclohexanone 70.0% by mass): 50.0 parts by mass

(Polyurethane resin: Number average molecular weight Mn=25000, glass transition temperature Tg=70° C.)

n-butyl stearate: 2.0 parts by mass

Methyl ethyl ketone: 108.2 parts by mass

Toluene: 108.2 parts by mass

Cyclohexanone: 100.0 parts by mass

Finally, 1.5 parts by mass of polyisocyanate (trade name: Coronate L, manufactured by Tosoh Corporation) as a curing agent and 2.0 parts by mass of stearic acid were added to the underlayer forming coating material prepared as described above.

### (Preparation Step of Back Layer Forming Coating Material)

A back layer forming coating material was prepared as follows. The following raw materials were mixed in a stirring tank provided with a disperser and subjected to filter treatment to prepare the back layer forming coating material.

Carbon black (manufactured by Asahi Carbon Co., Ltd., trade name: #80): 100.0 parts by mass

Polyurethane resin solution (resin solution: blending amount of polyurethane resin 30.0% by mass, blending amount of cyclohexanone 70.0% by mass) (manufactured by Nippon Polyurethane Industry Co., Ltd., trade name: N-2304): 150.0 parts by mass

Methyl ethyl ketone: 500.0 parts by mass

Toluene: 400.0 parts by mass

Cyclohexanone: 100.0 parts by mass

Polyisocyanate (trade name: Coronate L, manufactured by Tosoh Corporation): 9.0 parts by mass

### (Application Step)

An underlayer and a magnetic layer were formed in the following manner on one principal surface of an elongated polyethylene naphthalate film (hereinafter referred to as “PEN film”) having an average thickness of 4.00 μm, which is a base film (base), using the magnetic layer forming coating material and the underlayer forming coating material prepared as described above. First, the underlayer forming coating material was applied onto one principal surface of the PEN film to be dried to form an underlayer so that the average thickness was 0.75 μm after the calendering treatment. Next, the magnetic layer forming coating material was applied onto the underlayer to be dried to form a magnetic layer so that the average thickness was 0.06 μm after the calendering treatment. When the magnetic layer forming coating material is dried, magnetic field orientation of the ferrite particles in the thickness direction of the film was performed by a solenoid coil. Therefore, the square ratio S1 of the magnetic tape in the vertical direction (thickness direction) was set to 65%, and the square ratio S2 of the magnetic tape in the longitudinal direction was set to 38%.

After the underlayer and the magnetic layer were formed, the back layer forming coating material was applied onto the other principal surface of the PEN film to be dried to form a back layer so that the average thickness was 0.35 μm after the calendering treatment. Therefore, the magnetic tape was obtained.

### (Curing Step)

After the magnetic tape is wound into a roll shape, heat treatment is performed at 60° C. for 50 hours in this state to the magnetic tape to cure the underlayer and the magnetic layer.

### (Calendering Step)

The calendering treatment was performed to the magnetic tape after curing to smooth a surface of the magnetic layer. At this time, the calendering treatment temperature was 100° C., and the calendering treatment pressure was 200 kg/cm.

### (Cutting Step)

The magnetic tape obtained as described above was cut into a width of ½ inch (12.65 mm). Therefore, a magnetic tape having an average thickness of 5.16 μm was obtained.

### (Servo Pattern Writing Step)

After the magnetic tape after cutting was demagnetized, a servo pattern was written on the magnetic tape using a servo writer to form five servo bands. The servo pattern conforms to the LTO-8 standard. As described above, a target magnetic tape was obtained.

### Example 2

In the preparation step of the magnetic layer forming coating material, 2.5 parts by mass of citric acid was blended instead of 3.0 parts by mass of phenylphosphonic acid of the first composition. In the curing step, the temperature of the heat treatment was changed from 60° C. to 70° C., and the time of the heat treatment was changed from 50 hours to 25 hours. The magnetic tape was obtained in a manner similar to Example 1 except for the above.

### Example 3

In the preparation step of the magnetic layer forming coating material, the magnetic powder A (see Table 2) was blended instead of the magnetic powder B (see Table 2), and 3.0 parts by mass of 4-hydroxybenzoic acid was blended instead of 3.0 parts by mass of phenylphosphonic acid of the first composition. In the curing step, the time for the heat treatment was changed from 50 hours to 25 hours. The magnetic tape was obtained in a manner similar to Example 1 except for the above.

### Example 4

In the preparation step of the magnetic layer forming coating material, 3.0 parts by mass of 4-hydroxybenzoic acid was blended instead of 3.0 parts by mass of phenylphosphonic acid of the first composition. In the curing step, the time for the heat treatment was changed from 50 hours to 25 hours. The magnetic tape was obtained in a manner similar to Example 1 except for the above.

### Reference Example 1

In the preparation step of the magnetic layer forming coating material, the magnetic powder C (see Table 2) was blended instead of the magnetic powder B (see Table 2), and 2.5 parts by mass of benzoic acid was blended instead of 3.0 parts by mass of phenylphosphonic acid of the first composition. In the curing step, the time for the heat treatment was changed from 50 hours to 25 hours. The magnetic tape was obtained in a manner similar to Example 1 except for the above.

### Comparative Example 1

In the curing step, the time for the heat treatment was changed from 50 hours to 25 hours. The magnetic tape was obtained in a manner similar to Example 1 except for the above.

### Comparative Example 2

In the preparation step of the magnetic layer forming coating material, 2.5 parts by mass of benzoic acid was blended instead of 3.0 parts by mass of phenylphosphonic acid of the first composition. In the curing step, the time for the heat treatment was changed from 50 hours to 25 hours. The magnetic tape was obtained in a manner similar to Example 1 except for the above.

### Comparative Example 3

In the preparation step of the magnetic layer forming coating material, 3.0 parts by mass of isophthalic acid was blended instead of 3.0 parts by mass of phenylphosphonic acid of the first composition. In the curing step, the time for the heat treatment was changed from 50 hours to 25 hours. The magnetic tape was obtained in a manner similar to Example 1 except for the above.

### Comparative Example 4

In the preparation step of the magnetic layer forming coating material, the magnetic powder A (see Table 2) was blended instead of the magnetic powder B (see Table 2), and phenylphosphonic acid was not blended in the first composition. In the curing step, the time for the heat treatment was changed from 50 hours to 25 hours. The magnetic tape was obtained in a manner similar to Example 1 except for the above.

### [Reduction Rate of Saturation Magnetization Ms]

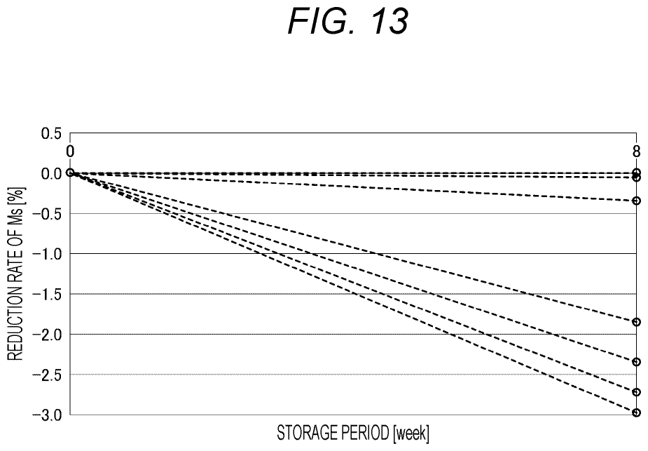

A reduction rate of the saturation magnetization Ms of the magnetic tape was measured by the method of measuring the reduction rate of the saturation magnetization Ms described in one embodiment described above. The results thereof are shown in Table 1 and FIG. 13.

[Attenuation Amount of Reproduction Signal after Lapse of 10 Years]

By the method of measuring the attenuation amount of the reproduction signal described in one embodiment described above, the attenuation amount of the reproduction signal after a lapse of 10 years, the reproduction signal being measured after storage for 8 weeks in an environment of a temperature of 60° C. and a humidity of 90 RH %, was measured. The results thereof are shown in Table 1.

TABLE 1

| | | | | | | | | | | | Attenuation |
|---|---|---|---|---|---|---|---|---|---|---|---|
| | | | | | | | | Heat | | Reduction | amount of |
| | Magnetic | Additive (acidic compound) | | | | Average | | treatment in | | rate of | reproduction |
| | tape | | | Blending | | particle | Rv/s | curing step | | saturation | signal |
| | average | | | amount | | volume | (= | Temper- | | magnetization | after lapse |
| | thickness | | | [parts by | Magnetic | Vave | Vave/ | ature | Time | Ms | of 10 years |
| | [μm] | Type | pKa | mass] | powder | [nm³] | Save) | [° C.] | [h] | [%/8 weeks] | [dB] |
| Example 1 | 5.16 | Phenylphosphonic | pKa | 3.0 | Magnetic | 1368 | 1.8 | 60 | 50 | −0.01 | 0.0 |
| | | acid | ≤5.0 (at | | powder B | | | | | | |
| | | | 25° C.) | | | | | | | | |
| Example 2 | 5.16 | Citric acid | pKa | 2.5 | Magnetic | 1368 | 1.8 | 70 | 25 | 0.05 | 0.5 |
| | | | ≤5.0 (at | | powder B | | | | | | |
| | | | 25° C.) | | | | | | | | |
| Example 3 | 5.16 | 4-hydroxybenzoic | pKa | 3.0 | Magnetic | 1164 | 1.7 | 60 | 25 | 0.40 | 0.9 |
| | | acid | ≤5.0 (at | | powder A | | | | | | |
| | | | 25° C.) | | | | | | | | |
| Example 4 | 5.16 | 4-hydroxybenzoic | pKa | 3.0 | Magnetic | 1368 | 1.8 | 60 | 25 | 0.10 | 0.6 |
| | | acid | ≤5.0 (at | | powder B | | | | | | |
| | | | 25° C.) | | | | | | | | |
| Reference | 5.16 | Benzoic acid | pKa | 2.5 | Magnetic | 1600 | 1.9 | 60 | 25 | 0.02 | 0.3 |
| Example 1 | | | ≤5.0 (at | | powder C | | | | | | |
| | | | 25° C.) | | | | | | | | |
| Comparative | 5.16 | Phenylphosphonic | pKa | 3.0 | Magnetic | 1368 | 1.8 | 60 | 25 | 1.85 | 1.8 |
| Example 1 | | acid | ≤5.0 (at | | powder B | | | | | | |
| | | | 25° C.) | | | | | | | | |
| Comparative | 5.16 | Benzoic acid | pKa | 2.5 | Magnetic | 1368 | 1.8 | 60 | 25 | 2.72 | 2.5 |
| Example 2 | | | ≤5.0 (at | | powder B | | | | | | |
| | | | 25° C.) | | | | | | | | |
| Comparative | 5.16 | Isophthalic acid | pKa | 3.0 | Magnetic | 1368 | 1.8 | 60 | 25 | 2.97 | 3.0 |
| Example 3 | | | ≤5.0 (at | | powder B | | | | | | |
| | | | 25° C.) | | | | | | | | |
| Comparative | 5.16 | — | — | — | Magnetic | 1164 | 1.7 | 60 | 25 | 2.35 | 2.3 |
| Example 4 | | | | | powder A | | | | | | |

TABLE 2

| | | Average | Average | Average | Average | |
|---|---|---|---|---|---|---|
| | | plate | plate | particle | particle | |
| | | diameter | thickness | volume | surface | |
| | | DBave | DAave | Vave | area Save | |
| | Type | [nm] | [nm] | [nm³] | [nm²] | Vave/Save |
| Magnetic | Barium ferrite (BaFe₁₂O₁₉) | 16.0 | 7.0 | 1164 | 669 | 1.7 |
| powder A | magnetic powder | | | | | |
| Magnetic | Barium ferrite (BaFe₁₂O₁₉) | 18.0 | 6.5 | 1368 | 772 | 1.8 |
| powder B | magnetic powder | | | | | |
| Magnetic | Barium ferrite (BaFe₁₂O₁₉) | 19.0 | 7.0 | 1640 | 870 | 1.9 |
| powder C | magnetic powder | | | | | |

The following can be seen from Table 1 and FIG. 13.

In the magnetic tape of Examples 1 to 4, since the reduction rate of the saturation magnetization Ms in an environment of a temperature of 60° C. and a humidity of 90 RH % is 1.00 [%/8 weeks] or less, even if the average particle volume of the ferrite particles is 1400 nm³ or less, the attenuation amount of the reproduction signal after a lapse of 10 years, the reproduction signal being measured after storage for 8 weeks in an environment of a temperature of 60° C. and a humidity of 90 RH %, can be 1.5 dB or less.

In the magnetic tape of Comparative Examples 1 to 4, since the reduction rate of the saturation magnetization Ms in an environment at a temperature of 60° C. and a humidity of 90 RH % is larger than 1.00 [%/8 weeks], when the average particle volume of the ferrite particles is 1400 nm³ or less, the attenuation amount of the reproduction signal after a lapse of 10 years, the reproduction signal being measured after storage for 8 weeks in an environment at a temperature of 60° C. and a humidity of 90 RH %, exceeds 1.5 dB.

In the magnetic tape of Reference Example 1, since the average particle volume of the ferrite particles is larger than 1400 nm³, the reduction rate of the saturation magnetization Ms in an environment of a temperature of 60° C. and a humidity of 90 RH % can be set to 1.00 [%/8 weeks] or less without adjusting the type and blending amount of the acidic compound in the preparation step of the coating material and the heat treatment conditions (heat treatment temperature and heat treatment time) in the curing step.

In the magnetic tape of Example 1 and the magnetic tape of Comparative Example 1, the same amount of phenylphosphonic acid is blended. However, the reduction rates of the saturation magnetization Ms in an environment of a temperature of 60° C. and a humidity of 90 RH& are greatly different between the magnetic tape of Example 1 and the magnetic tape of Comparative Example 1. This is considered to be due to the following reason. That is, the heat treatment time in the curing step of the magnetic tape of Comparative Example 1 is shorter than the heat treatment time in the curing step of the magnetic tape of Example 1. Therefore, it is considered that the amount of phenylphosphonic acid not adsorbed on the ferrite particle surface in the magnetic layer of Comparative Example 1 was larger than the amount of phenylphosphonic acid not adsorbed on the ferrite particle surface in the magnetic layer of Example 1.

In the magnetic tape of Reference Example 1 and the magnetic tape of Comparative Example 2, the same amount of benzoic acid was blended, and the conditions (heat treatment temperature and heat treatment time) of the heat treatment in the curing step were the same. However, the reduction rates of the saturation magnetization Ms in an environment of a temperature of 60° C. and a humidity of 90 RH % are greatly different between the magnetic tape of Example 1 and the magnetic tape of Comparative Example 1. This is considered to be due to the following reason. That is, the average particle volume Vₐᵥₑ of the ferrite particles in the magnetic tape of Reference Example 1 is larger than the average particle volume Vₐᵥₑ of the ferrite particles in the magnetic tape of Comparative Example 2. Furthermore, the ratio R_{V/S} in the magnetic tape of Reference Example 1 is larger than the ratio R_{V/S} in the magnetic tape of Comparative Example 2. For this reason, it is considered that even when benzoic acid contained in the magnetic layer was dissolved in water to generate an acidic aqueous solution, the influence of dissolution of the ferrite particles in the magnetic tape of Reference Example 1 was smaller than the influence of dissolution of the ferrite particles in the magnetic tape of Comparative Example 2.

The embodiment and modifications of the present disclosure have been specifically described above, but the present disclosure is not limited to the above-described embodiment and modifications, and various modifications based on the technical idea of the present disclosure can be made. For example, configurations, methods, steps, shapes, materials, numerical values, and the like in the above-described embodiment and modifications are merely examples, and different configurations, methods, steps, shapes, materials, numerical values, and the like may be employed as necessary. The configurations, methods, steps, shapes, materials, numerical values, and the like of the above-described embodiment and modifications can be combined with each other without departing from the gist of the present disclosure.

The chemical formulas of the compounds and the like exemplified in the above-described embodiment and modifications are representative, and are not limited to the described valences and the like as long as they are common names of the same compounds. In numerical value ranges described in stages in the embodiment and modifications described above, an upper limit value or a lower limit value of a numerical value range of a certain stage may be replaced with an upper limit value or a lower limit value of the numerical value range of another stage. The materials exemplified in the embodiment and modifications described above may be used alone or in combination of two or more unless otherwise specified.

Furthermore, the present disclosure may also employ the following configurations.

(1)

A magnetic recording medium in a tape shape, including:
a base; and
a magnetic layer containing ferrite particles and an acidic compound, in which
an average particle volume of the ferrite particles is 1400 nm³ or less, and
a reduction rate of a saturation magnetization Ms in an environment at a temperature of 60° C. and a humidity of 90 RH % is 1.00 [%/8 weeks] or less.
   (2)

The magnetic recording medium according to (1), in which
a ratio (Vₐᵥₑ/Sₐᵥₑ) of an average particle volume Vₐᵥₑ of the ferrite particles to an average particle surface area Sₐᵥₑ of the ferrite particles is 1.8 or less.
   (3)

The magnetic recording medium according to (1) or (2), in which
the acidic compound includes at least one acidic functional group.
   (4)

The magnetic recording medium according to (3), in which
the at least one acidic functional group contains at least one selected from the group consisting of a phosphate group, a carboxyl group, and a sulfonic acid group.
   (5)

The magnetic recording medium according to (1) or (2), in which
the at least one acidic compound contains at least one selected from the group consisting of phenylphosphonic acid, benzoic acid, naphthoic acid, hydroxybenzoic acid, isophthalic acid, oleic acid, cyclohexanecarboxylic acid, adipic acid, and citric acid.
   (6)

The magnetic recording medium according to any one of (1) to (5), in which
the acidic compound is configured to be adsorbable to the ferrite particles.
   (7)

The magnetic recording medium according to any one of (1) to (6), in which
the acidic compound contains a dispersant.
   (8)

The magnetic recording medium according to any one of (1) to (7), in which
the ferrite particles contain hexagonal ferrite particles.
   (9)

The magnetic recording medium according to any one of (1) to (7), in which
the ferrite particles contain ε-iron oxide particles or Co-containing spinel ferrite particles.
   (10)

The magnetic recording medium according to any one of (1) to (9), in which
an acid dissociation constant (pKa) of the acidic compound is 5.0 or less.
   (11)

The magnetic recording medium according to any one of (1) to (10), in which
a reduction rate of the saturation magnetization Ms is 0.40 [%/8 weeks] or less.
   (12)

The magnetic recording medium according to any one of (1) to (11), in which
an attenuation amount of a reproduction signal after a lapse of 10 years, the reproduction signal being measured after storage for 8 weeks in an environment of a temperature of 60° C. and a humidity of 90 RH %, is 1.5 dB or less.
   (13)

The magnetic recording medium according to any one of (1) to (11), in which
an attenuation amount of a reproduction signal after a lapse of 10 years, the reproduction signal being measured after storage for 8 weeks in an environment of a temperature of 60° C. and a humidity of 90 RH %, is 0.9 dB or less.
   (14)

The magnetic recording medium according to any one of (1) to (13), in which
an average thickness of the magnetic recording medium is 5.30 μm or less.
   (15)

The magnetic recording medium according to any one of (1) to (13), in which
an average thickness of the magnetic recording medium is 5.30 μm, and
the magnetic layer is configured to be capable of recording a signal with a data track width of 800 nm or less and a bit length of 46 nm or less.
   (16)

The magnetic recording medium according to any one of (1) to (15), in which
an average thickness of the magnetic layer is 0.08 μm or less, and
an average thickness of the base is 4.40 μm or less.
   (17)

The magnetic recording medium according to any one of (1) to (16), further including
an underlayer, in which
an average thickness of the underlayer is 0.90 μm or less.
   (18)

The magnetic recording medium according to any one of (1) to (17), in which
the magnetic layer includes a servo pattern,
the servo pattern includes a plurality of first magnetization regions and a plurality of second magnetization regions, and
the plurality of first magnetization regions and the plurality of second magnetization regions are asymmetric with respect to an axis parallel to a width direction of the magnetic recording medium.
   (19)

The magnetic recording medium according to (18), in which
an inclination angle of the first magnetization region with respect to the axis is different from an inclination angle of the second magnetization region with respect to the axis, and
a larger one of the inclination angle of the first magnetization region and the inclination angle of the second magnetization region is 18° or more and 28° or less.
   (20)

A cartridge including
the magnetic recording medium according to any one of (1) to (19).

### REFERENCE SIGNS LIST

10, 321 Cartridge
11 Cartridge memory
31 Antenna coil
32 Rectification/power supply circuit
33 Clock circuit
34 Detection/modulation circuit
35 Controller
36 Memory
36A First storage region
36B Second storage region
41 Base
42 Underlayer
43 Magnetic layer
44 Back layer
56 Head unit
56A, 56B Servo read head
110 Servo frame
111 Servo subframe 1
112 Servo subframe 2
113 Servo stripe
111A A burst
111B B burst
112C C burst
112D D burst
MT Magnetic tape
SB Servo band
DB Data band
Tk Data track

1. A magnetic recording medium in a tape shape, comprising:
a base; and
a magnetic layer containing ferrite particles and an acidic compound, wherein
an average particle volume of the ferrite particles is 1400 nm³ or less, and
a reduction rate of a saturation magnetization Ms in an environment at a temperature of 60° C. and a humidity of 90 RH % is 1.00 [%/8 weeks] or less.

2. The magnetic recording medium according to claim 1, wherein
a ratio (Vₐᵥₑ/Sₐᵥₑ) of an average particle volume Vₐᵥₑ of the ferrite particles to an average particle surface area Sₐᵥₑ of the ferrite particles is 1.8 or less.

3. The magnetic recording medium according to claim 1, wherein
the acidic compound includes at least one acidic functional group.

4. The magnetic recording medium according to claim 3, wherein
the at least one acidic functional group contains at least one selected from the group consisting of a phosphate group, a carboxyl group, and a sulfonic acid group.

5. The magnetic recording medium according to claim 1, wherein
the at least one acidic compound contains at least one selected from the group consisting of phenylphosphonic acid, benzoic acid, naphthoic acid, hydroxybenzoic acid, isophthalic acid, oleic acid, cyclohexanecarboxylic acid, adipic acid, and citric acid.

6. The magnetic recording medium according to claim 1, wherein
the acidic compound is configured to be adsorbable to the ferrite particles.

7. The magnetic recording medium according to claim 1, wherein
the acidic compound contains a dispersant.

8. The magnetic recording medium according to claim 1, wherein
the ferrite particles contain hexagonal ferrite particles.

9. The magnetic recording medium according to claim 1, wherein
the ferrite particles contain ε-iron oxide particles or Co-containing spinel ferrite particles.

10. The magnetic recording medium according to claim 1, wherein
an acid dissociation constant (pKa) of the acidic compound is 5.0 or less.

11. The magnetic recording medium according to claim 1, wherein
a reduction rate of the saturation magnetization Ms is 0.40 [%/8 weeks] or less.

12. The magnetic recording medium according to claim 1, wherein
an attenuation amount of a reproduction signal after a lapse of 10 years, the reproduction signal being measured after storage for 8 weeks in an environment of a temperature of 60° C. and a humidity of 90 RH %, is 1.5 dB or less.

13. The magnetic recording medium according to claim 1, wherein
an attenuation amount of a reproduction signal after a lapse of 10 years, the reproduction signal being measured after storage for 8 weeks in an environment of a temperature of 60° C. and a humidity of 90 RH %, is 0.9 dB or less.

14. The magnetic recording medium according to claim 1, wherein
an average thickness of the magnetic recording medium is 5.30 μm or less.

15. The magnetic recording medium according to claim 1, wherein
an average thickness of the magnetic recording medium is 5.30 μm, and
the magnetic layer is configured to be capable of recording a signal with a data track width of 800 nm or less and a bit length of 46 nm or less.

16. The magnetic recording medium according to claim 1, wherein
an average thickness of the magnetic layer is 0.08 μm or less, and
an average thickness of the base is 4.40 μm or less.

17. The magnetic recording medium according to claim 1, further comprising
an underlayer, wherein
an average thickness of the underlayer is 0.90 μm or less.

18. The magnetic recording medium according to claim 1, wherein
the magnetic layer includes a servo pattern,
the servo pattern includes a plurality of first magnetization regions and a plurality of second magnetization regions, and
the plurality of first magnetization regions and the plurality of second magnetization regions are asymmetric with respect to an axis parallel to a width direction of the magnetic recording medium.

19. The magnetic recording medium according to claim 18, wherein
an inclination angle of the first magnetization region with respect to the axis is different from an inclination angle of the second magnetization region with respect to the axis, and
a larger one of the inclination angle of the first magnetization region and the inclination angle of the second magnetization region is 18° or more and 28° or less.

20. A cartridge comprising
the magnetic recording medium according to claim 1.
